(19) United States
(12) Patent Application Publication
(10) Pub. No.: US 2026/0032286 A1
(43) Pub. Date: Jan. 29, 2026

(54) POINT CLOUD ENCODING/DECODING METHOD AND APPARATUS, AND DEVICE AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/350,255

(22) Filed: Oct. 6, 2025

Related U.S. Application Data
(63) Continuation of application No. PCT/CN2023/086994, filed on Apr. 7, 2023.

(51) Int. Cl. H04N 19/597; H04N 19/105; H04N 19/119; H04N 19/176

(52) U.S. Cl. CPC H04N 19/597; H04N 19/105; H04N 19/119; H04N 19/176

(57) ABSTRACT

A point cloud decoding method is provided. The point cloud decoding method includes: determining M neighborhood blocks corresponding to a current point in a reference picture of the current point, wherein the current point is a point in a point cloud whose attribute information is to be decoded, M being a positive integer; and determining an attribute prediction value of the current point based on attribute information of points comprised in the M neighborhood blocks.

### CROSS-REFERENCE TO RELATED APPLICATION

This application is a Continuation Application of International Application No. PCT/CN2023/086994 filed on Apr. 7, 2023, which is incorporated herein by reference in its entirety.

### TECHNICAL FIELD

The present disclosure relates to the technical field of point cloud, and in particular, to a point cloud encoding and decoding method and apparatus, a device and a storage medium.

### BACKGROUND

A surface of an object is captured by a collection device to form point cloud data, which includes hundreds of thousands or even more points. In a process of video production, the point cloud data is transmitted between a point cloud encoding device and a point cloud decoding device in a form of a point cloud media file. However, such a large number of points brings challenges to transmission, and thus, the point cloud encoding device needs to compress the point cloud data before transmission.

Point cloud compression is also referred to as point cloud encoding. In a process of attribute encoding of the point cloud, at least one neighboring point of a current point is first determined from reference points in a prediction reference buffer; an attribute prediction value of the current point is determined based on attribute information of the at least one neighboring point; an attribute residual value of the current point is determined based on attribute information of the current point and the attribute prediction value of the current point, and the attribute residual value is encoded. However, at present, the determined neighboring point is inaccurate, resulting in poor attribute encoding and decoding performance.

### SUMMARY

The embodiments of the present disclosure provide a point cloud encoding and decoding method and apparatus, a device and a storage medium.

In a first aspect, the embodiments of the present disclosure provide a point cloud decoding method, which includes:
determining M neighborhood blocks corresponding to a current point in a reference picture of the current point, where the current point is a point in a point cloud whose attribute information is to be decoded, M being a positive integer; and
determining an attribute prediction value of the current point based on attribute information of points included in the M neighborhood blocks.

In a second aspect, the present disclosure provides a point cloud encoding method, which includes:
determining M neighborhood blocks corresponding to a current point in a reference picture of the current point, where the current point is a point in a point cloud whose attribute information is to be encoded, M being a positive integer; and
determining an attribute prediction value of the current point based on attribute information of points included in the M neighborhood blocks.

In a third aspect, the present disclosure provides a point cloud decoding apparatus, which is used to perform the method(s) in the above first aspect or its various implementations. Exemplarily, the apparatus includes functional units for performing the method(s) in the above first aspect or its various implementations.

In a fourth aspect, the present disclosure provides a point cloud encoding apparatus, which is used to perform the method(s) in the above second aspect or its various implementations. Exemplarily, the apparatus includes functional units for performing the method(s) in the above second aspect or its various implementations.

In a fifth aspect, a point cloud decoder is provided, which includes a processor and a memory. The memory is configured to store a computer program, and the processor is configured to call the computer program stored in the memory and run the computer program, to perform the method(s) in the above first aspect or its various implementations.

In a sixth aspect, a point cloud encoder is provided, which includes a processor and a memory. The memory is configured to store a computer program, and the processor is configured to call the computer program stored in the memory and run the computer program, to perform the method(s) in the above second aspect or its various implementations.

In a seventh aspect, a point cloud encoding and decoding system is provided, which includes a point cloud encoder and a point cloud decoder. The point cloud decoder is used to perform the method(s) in the above first aspect or its various implementations, and the point cloud encoder is used to perform the method(s) in the above second aspect or its various implementations.

In an eighth aspect, a chip is provided, which is used to implement the method(s) in any one of the first to second aspects or their various implementations. Exemplarily, the chip includes a processor, which is configured to call a computer program from a memory and run the computer program, to enable a device equipped with the chip to perform the method(s) in any one of the first to second aspects or their various implementations.

In a ninth aspect, a non-transitory computer-readable storage medium is provided, which is used to store a computer program, and the computer program enables a computer to perform the method(s) in any one of the first to second aspects or their various implementations.

In a tenth aspect, a computer program product is provided, which includes computer program instructions, where the computer program instructions enable a computer to perform the method(s) in any one of the first to second aspects or their various implementations.

In an eleventh aspect, a computer program is provided, where the computer program, when executed on a computer, enables a computer to perform the method(s) in any one of the first to second aspects or their various implementations.

In a twelfth aspect, a bitstream is provided, and the bitstream is generated based on the method in the second aspect.

In a thirteenth aspect, there is provided a non-transitory computer-readable storage medium. The non-transitory computer-readable storage medium has a computer program and a bitstream stored thereon, and the computer program, when executed by a processor, enables the processor to perform the method described in the second aspect, to generate the bitstream.

### BRIEF DESCRIPTION OF THE DRAWINGS

FIG. 1A is a schematic diagram of a point cloud.

FIG. 1B is a partially enlarged diagram of a point cloud.

FIG. 2 is a schematic diagram of a point cloud picture at six viewing angles.

FIG. 3 is a schematic block diagram of a point cloud encoding and decoding system involved in the embodiments of the present disclosure.

FIG. 4A is a schematic block diagram of a point cloud encoder provided in the embodiments of the present disclosure.

FIG. 4B is a schematic block diagram of a point cloud decoder provided in the embodiments of the present disclosure.

FIG. 5A is a schematic diagram of a plane.

FIG. 5B is a schematic diagram of a node coding sequence.

FIG. 5C is a schematic diagram of a planar flag.

FIG. 5D is a schematic diagram of sibling nodes.

FIG. 5E is a schematic diagram of an intersection of a laser radar and a node.

FIG. 5F is a schematic diagram of a neighborhood node at the same partitioning depth and the same coordinate.

FIG. 5G is a schematic diagram of neighborhood nodes in a case where a node is located at a lower plane position of a parent node.

FIG. 5H is a schematic diagram of neighborhood nodes in a case where a node is located at a high plane position of a parent node.

FIG. 5I is a schematic diagram of predictive encoding of planar position information of a laser radar point cloud.

FIG. 6 is a schematic diagram of infer direct coding model (IDCM) coding.

FIG. 7A to FIG. 7C are schematic diagrams of triangle soup-based geometry information coding.

FIG. 8A is a schematic diagram of a distance-based level-of-detail (LOD) construction.

FIG. 8B is a subjective schematic diagram of a distance-based LOD generation process.

FIG. 8C is a flowchart of predictive encoding.

FIG. 8D is a schematic diagram of a LOD partitioning.

FIG. 8E is a schematic diagram of inter-level nearest neighbor search.

FIG. 8F is a schematic diagram of performing nearest neighbor search based on a spatial relationship.

FIG. 8G is a schematic diagram of nearest neighbor search for a co-planar, co-edge and co-vertex.

FIG. 8H is a schematic diagram of a neighboring points search.

FIG. 8I is a schematic diagram of a neighboring points search.

FIG. 8J is a schematic diagram of a neighboring points search based on a fast search algorithm.

FIG. 8K is a schematic diagram of an inter nearest neighbor search.

FIG. 8L is a flowchart of a lifting transform.

FIG. 8M is a schematic diagram of a region adaptive hierarchical transform (RAHT) transform process along x, y and z directions.

FIG. 8N is a schematic diagram of a RAHT transform.

FIG. 8O is a schematic diagram of RAHT forward transform and inverse transform.

FIG. 9 is a schematic flowchart diagram of a point cloud decoding method provided in the embodiments of the present disclosure.

FIG. 10 is a schematic diagram for determining a collocated block.

FIG. 11 is a schematic diagram of neighborhood blocks.

FIG. 12 is a schematic diagram for determining a collocated block of a first spatial block.

FIG. 13 is another schematic diagram for determining a collocated block of a first spatial block.

FIG. 14 is a schematic flowchart of a point cloud encoding method provided in the embodiments of the present disclosure.

FIG. 15 is a schematic block diagram of a point cloud decoding apparatus provided in the embodiments of the present disclosure.

FIG. 16 is a schematic block diagram of a point cloud encoding apparatus provided in the embodiments of the present disclosure.

FIG. 17 is a schematic block diagram of an electronic device provided in the embodiments of the present disclosure.

FIG. 18 is a schematic block diagram of a point cloud encoding and decoding system provided in the embodiments of the present disclosure.

### DETAILED DESCRIPTION

The present disclosure may be applied to the technical field of point cloud upsampling, for example, may be applied to the technical field of point cloud compression.

In order to facilitate understanding of the embodiments of the present disclosure, related concepts involved in the embodiments of the present disclosure are briefly introduced as follows firstly.

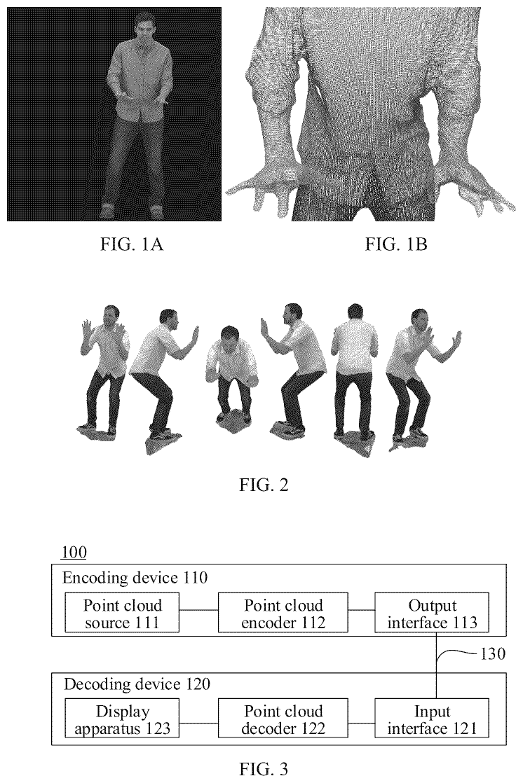

A point cloud refers to a set of discrete points in space that are irregularly distributed and express spatial structures and surface attributes of three-dimensional objects or three-dimensional scenarios. FIG. 1A is a schematic diagram of a three-dimensional point cloud picture, and FIG. 1B is a partially enlarged diagram of FIG. 1A. It may be seen from FIG. 1A and FIG. 1B that a point cloud surface is composed of densely distributed points.

A two-dimensional picture has information expression at each sample point (also referred to as pixel point), and the distribution is regular, so there is no need to record its position information additionally. However, distribution of points in a point cloud is random and irregular in three-dimensional space, so it is necessary to record a position of each point in space to completely express the entire point cloud. Similar to the two-dimensional picture, during a capturing process, each position has corresponding attribute information.

Point cloud data is a specific record form of a point cloud. A point in the point cloud may include position information of the point and attribute information of the point. For example, the position information of the point may be three-dimensional coordinate information of the point. The position information of the point may also be referred to as geometry information of the point. For example, the attribute information of the point may include color information, reflectance information, normal vector information, or the like. The color information reflects a color of an object, and the reflectance information reflects a surface material of an object. The color information may be information in any color space. For example, the color information may be RGB. For another example, the color information may be luma-chroma (YCbCr, YUV) information. For example, Y represents luminance (Luma), Cb (U) represents blue chromatic aberration, Cr (V) represents red chromatic aberration, and U and V represent chroma for describing chromatic aberration information. For example, for a point cloud obtained according to the laser measurement principle, a point in the point cloud may include three-dimensional coordinate information of the point and laser reflectance intensity of the point. For another example, for a point cloud obtained according to the photogrammetry principle, a point in the point cloud may include three-dimensional coordinate information of the point and color information of the point. For another example, for a point cloud obtained by combining the laser measurement principle and photogrammetry principle, a point in the point cloud may include three-dimensional coordinate information of the point, laser reflectance intensity of the point and color information of the point. FIG. 2 illustrates a point cloud picture, where FIG. 2 illustrates six viewing angles of the point cloud picture. Table 1 illustrates a point cloud data storage format consisting of a file header information part and a data part.

TABLE 1

| | |
|---|---|
| 1 | ply |
| 2 | format ascii 1.0 |
| 3 | element vertex 207242 |
| 4 | property float x |
| 5 | property float y |
| 6 | property float z |
| 7 | property uchar red |
| 8 | property uchar green |
| 9 | property uchar blue |
| 10 | end_header |
| 11 | 75 318 0 0 142 0 |
| 12 | 75 319 0 0 143 0 |
| 13 | 75 319 1 1 9 9 |
| 14 | 77 315 0 1 9 9 |

In Table 1, the header information includes a data format, a data representation type, the total number of points of a point cloud, and content represented by the point cloud. For example, the point cloud in this example is in “.ply” format, represented by ASCII code, with a total number of 207,242 points, and each point has three-dimensional position information XYZ and three-dimensional color information RGB.

The point cloud may express the spatial structures and the surface attributes of three-dimensional objects or three-dimensional scenarios flexibly and conveniently; moreover, since the point cloud is acquired by directly sampling real objects, the point cloud may provide a strong sense of reality under the premise of ensuring accuracy; and therefore, the point cloud is widely applied, and its application range includes virtual reality games, computer-aided design, geographic information systems, automatic navigation systems, digital cultural heritage, free-viewpoint broadcasting, three-dimensional immersive remote presentation, and three-dimensional reconstruction of biological tissues and organs or the like.

Acquisition approaches for the point cloud may include, but are not limited to, at least one of the following: (1) generated by a computer device, the computer device may generate the point cloud data based on virtual three-dimensional objects and virtual three-dimensional scenarios; (2) acquired by 3-Dimension (3D) laser scanning, where point cloud data of three-dimensional objects or three-dimensional scenarios of static real world may be acquired by the 3D laser scanning, and millions of point cloud data may be acquired per second; (3) acquired by 3D photogrammetry, where visual scenarios of real world are collected by a 3D photography device (i.e., a group of cameras or a camera device with multiple lenses and multiple sensors), to acquire point cloud data of the visual scenarios in real world, and point cloud data of three-dimensional objects or three-dimensional scenarios of dynamic real world may be acquired by 3D photography; or (4) point cloud data of biological tissues and organs acquired by a medical device, where in the medical field, the point cloud data of biological tissues and organs may be acquired by a medical device such as a magnetic resonance imaging (MRI), a computed tomography (CT), and an electromagnetic positioning system.

Point clouds may be classified into dense point clouds and sparse point clouds according to acquisition approaches.

The point clouds are classified into the following types according to a time series of the data:
first type: static point cloud, where an object is static, and a device for acquiring the point cloud is also static;
second type: dynamic point cloud, where an object is dynamic, but a device for acquiring the point cloud is static; and
third type: dynamically acquired point cloud, where a device for acquiring the point cloud is dynamic.

The point clouds may be classified into two types according to purposes:
type I: a machine perception point cloud, which may be used for scenarios such as, an autonomous navigation system, a real-time inspection system, a geographic information system, a visual sorting robot and a disaster relief robot; and
type II: a human eye perception point cloud, which may be used for point cloud application scenarios such as, digital cultural heritage, free viewpoint broadcasting, 3D immersive communication and 3D immersive interaction.

Through the above point cloud acquiring technologies, the cost and time period for acquiring the point cloud data are reduced and the accuracy of the data is improved. The change in the acquisition approaches for point cloud data makes it possible to acquire a large amount of point cloud data. However, with the growth of application demand, the processing of massive 3D point cloud data has encountered the bottleneck in storage space and transmission bandwidth limitation.

Taking a point cloud video with a frame rate of 30 frames per second (fps) as an example, the number of points of the point cloud per frame is 700,000, and each point has coordinate information xyz (float) and color information RGB (uchar); and thus, the data volume of a 10s point cloud video is approximately 0.7 million×(4 Byte×3+1 Byte×3)×30 fps×10s=3.15 GB. For a two-dimensional video with a YUV sampling format of 4:2:0, a resolution of 1280×720 and a frame rate of 24 fps, the data volume of a 10s video is approximately 1280×720×12 bit×24 frames×10s≈0.33 GB, and the data volume of a 10s three-dimensional video with two-viewpoints is approximately 0.33×2=0.66 GB. It can be seen that, for videos with the same length, the data volume of point cloud video is much larger than that of two-dimensional video or that of three-dimensional video. Therefore, in order to better realize data management, save server storage space and reduce the transmission traffic and transmission time between the server and the client, point cloud compression has become a key issue to promote the development of the point cloud industry.

Related knowledge of point cloud encoding and decoding is introduced below.

FIG. 3 is a schematic block diagram of a point cloud encoding and decoding system involved in an embodiment of the present disclosure. It is to be noted that FIG. 3 only illustrates an example, and the point cloud encoding and decoding system in the embodiments of the present disclosure includes but is not limited to that illustrated in FIG. 3. As illustrated in FIG. 3, the point cloud encoding and decoding system 100 includes an encoding device 110 and a decoding device 120. The encoding device is configured to encode (which may be understood as compress) the point cloud data to generate a bitstream, and transmit the bitstream to the decoding device. The decoding device is configured to decode the bitstream generated by the encoding device to obtain decoded point cloud data.

The encoding device 110 in the embodiments of the present disclosure may be understood as a device with a point cloud encoding function, and the decoding device 120 may be understood as a device with a point cloud decoding function. That is, in the embodiments of the present disclosure, the encoding device 110 and the decoding device 120 includes multiple types of devices, such as smartphones, desktop computers, mobile computing apparatuses, notebook (e.g., laptop) computers, tablet computers, set-top boxes, televisions, cameras, display devices, digital media players, point cloud game consoles, and vehicle-mounted computers.

In some embodiments, the encoding device 110 may transmit the encoded point cloud data (e.g., the bitstream) to the decoding device 120 via a channel 130. The channel 130 may include one or more media and/or apparatuses which are capable of transmitting the encoded point cloud data from the encoding device 110 to the decoding device 120.

In an instance, the channel 130 includes one or more communication media that enable the encoding device 110 to transmit the encoded point cloud data directly to the decoding device 120 in real time. In this instance, the encoding device 110 may modulate the encoded point cloud data according to a communication standard and transmit the modulated point cloud data to the decoding device 120. The communication medium includes a wireless communication medium, such as, a radio frequency spectrum. Optionally, the communication medium may also include a wired communication medium, such as, one or more physical transmission lines.

In another instance, the channel 130 includes a storage medium, and the storage medium may store the point cloud data encoded by the encoding device 110. The storage medium includes a variety of locally accessible data storage media, such as an optical disk, a DVD, and a flash memory. In this instance, the decoding device 120 may acquire the encoded point cloud data from the storage medium.

In yet another instance, the channel 130 may include a storage server, and the storage server may store the point cloud data encoded by the encoding device 110. In this instance, the decoding device 120 may download the encoded point cloud data stored in the storage server from the storage server. Optionally, the storage server may store the encoded point cloud data and transmit the encoded point cloud data to the decoding device 120, such as a web server (e.g., for a website), a file transfer protocol (FTP) server, or the like.

In some embodiments, the encoding device 110 includes a point cloud encoder 112 and an output interface 113. The output interface 113 may include a modulator/demodulator (modem) and/or a transmitter.

In some embodiments, the encoding device 110 may further include a point cloud source 111 in addition to the point cloud encoder 112 and the output interface 113.

The point cloud source 111 may include at least one of: a point cloud collection apparatus (e.g., a scanner), a point cloud archive, a point cloud input interface, or a computer graphics system, where the point cloud input interface is used to receive point cloud data from a point cloud content provider, and the computer graphics system is used to generate the point cloud data.

The point cloud encoder 112 encodes the point cloud data from the point cloud source 111 to generate a bitstream. The point cloud encoder 112 transmits the encoded point cloud data directly to the decoding device 120 via the output interface 113. The encoded point cloud data may also be stored in a storage medium or a storage server for subsequent reading by the decoding device 120.

In some embodiments, the decoding device 120 includes an input interface 121 and a point cloud decoder 122.

In some embodiments, the decoding device 120 may further include a display apparatus 123 in addition to the input interface 121 and the point cloud decoder 122.

The input interface 121 includes a receiver and/or a modem. The input interface 121 may receive the encoded point cloud data through the channel 130.

The point cloud decoder 122 is used to decode the encoded point cloud data to obtain decoded point cloud data, and transmit the decoded point cloud data to the display apparatus 123.

The display apparatus 123 displays the decoded point cloud data. The display apparatus 123 may be integrated with the decoding device 120 or external to the decoding device 120. The display apparatus 123 may include a variety of display apparatuses, such as a liquid crystal display (LCD), a plasma display, an organic light emitting diode (OLED) display, or other types of display devices.

In addition, FIG. 3 only illustrates an example, and the technical solution of the embodiments of the present disclosure is not limited to FIG. 3. For example, the technology of the present disclosure may also be applied to unilateral point cloud encoding or unilateral point cloud decoding.

The current point cloud encoder may adopt two point cloud compression coding technology routes proposed by the Moving Picture Experts Group (MPEG) of the international standards organization, namely Video-based Point Cloud Compression (VPCC) and Geometry-based Point Cloud Compression (GPCC). The VPCC projects a 3D point cloud into 2D and encodes a projected 2D picture using existing 2D coding tools. The GPCC partitions a point cloud into multiple units step by step using a hierarchical structure and encodes the entire point cloud by encoding and recording the partitioning process.

The point cloud encoder and the point cloud decoder applicable to the embodiments of the present disclosure are described below by taking the GPCC encoding and decoding framework as an example.

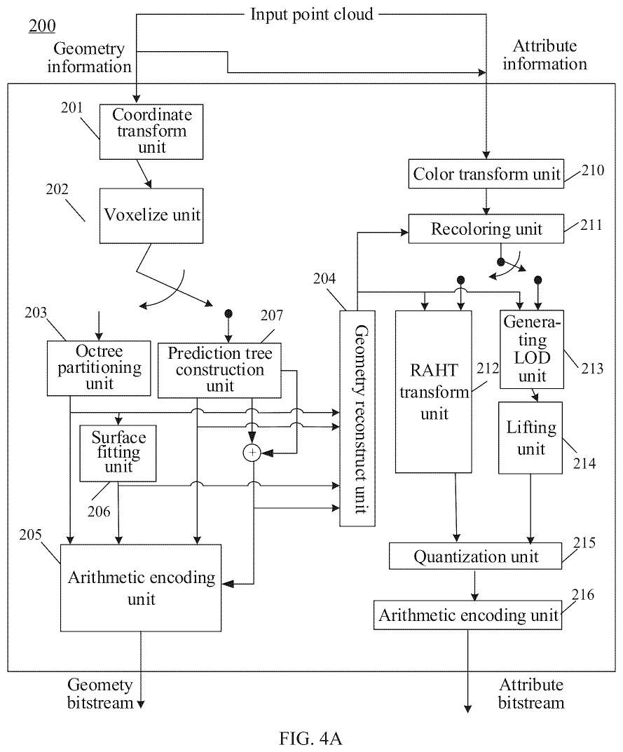

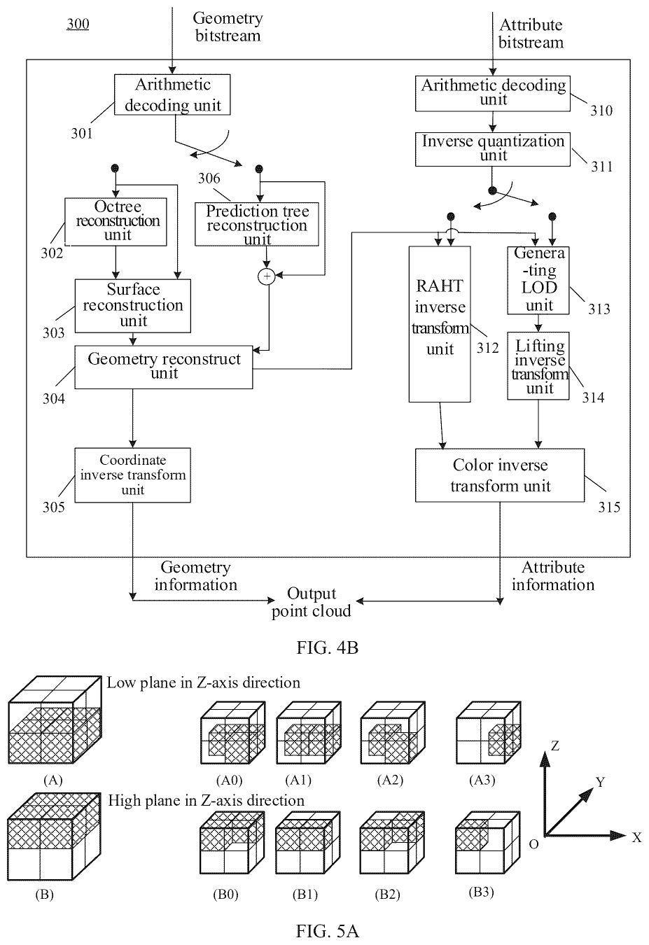

FIG. 4A is a schematic block diagram of a point cloud encoder provided in an embodiment of the present disclosure.

As can be seen from the above, a point in the point cloud may include position information of the point and attribute information of the point. Therefore, the encoding of the point in the point cloud mainly includes position encoding and attribute encoding. In some examples, the position information of the point in the point cloud is also referred to as geometry information; and correspondingly, the position encoding of the point in the point cloud may also be referred to as geometric encoding.

In the GPCC encoding framework, the geometry information of the point cloud and the corresponding attribute information of the point cloud are encoded separately.

As illustrated in FIG. 4A below, the current G-PCC geometric encoding and decoding may be classified into octree-based geometric encoding and decoding and predictive tree-based geometric encoding and decoding.

A process of the position encoding includes: performing preprocessing (e.g., coordinate transform, quantization, and removal of duplicate points) on the points in the point cloud; and then, performing geometric encoding on the preprocessed point cloud, e.g., constructing an octree or constructing a predictive tree, and performing geometric encoding on the constructed octree or predictive tree to form a geometry bitstream. At the same time, based on the position information output by the constructed octree or predictive tree, position information of each point in the point cloud data is reconstructed to obtain a reconstructed value of the position information of each point.

A process of the attribute encoding includes: selecting one of three prediction modes to perform point cloud prediction through given reconstructed information of position information and an original value of attribute information of an input point cloud, quantizing the predicted result, and performing arithmetic encoding to form an attribute bitstream.

As illustrated in FIG. 4A, the position encoding may be implemented by the following units:
a coordinate transform (transform coordinates) unit 201, a voxelize unit 202, an octree partitioning (analyze octree) unit 203, a geometry reconstruct (reconstruct geometry) unit 204, an arithmetic encode unit 205, a surface fitting (analyze surface approximation) unit 206, and a predictive tree construction unit 207.

The coordinate transform unit 201 may be used to transform world coordinates of a point in the point cloud into relative coordinates. For example, subtracting the minimum values of the xyz coordinate axis from geometry coordinates of the point respectively is equivalent to a direct current removal operation, to implement the transform of the coordinates of the point in the point cloud from the world coordinates to the relative coordinates.

The voxelize unit 202 is also referred to as a quantize and remove duplicate points (quantize and remove points) unit; the number of coordinates may be reduced through quantization; after quantization, originally different points may be assigned the same coordinates; and based on which, duplicate points may be removed through a deduplication operation. For example, multiple clouds with the same quantized position and different pieces of attribute information may be merged into one cloud by attribute transform. In some embodiments of the present disclosure, the voxelize unit 202 is an optional unit module.

The octree partitioning unit 203 may encode the position information of the quantized points using an octree coding manner. For example, the point cloud is partitioned in an octree form, so that positions of the points in the point cloud may be in one-to-one correspondence with positions of the octree. By counting the positions in the octree that contain points and marking their flags as 1, the geometric encoding is performed.

In some embodiments, in a process of geometry information encoding based on trianglesoup (trisoup), octree partitioning is also performed on the point cloud through the octree partitioning unit 203. However, different from the manner of the octree-based geometry information encoding, the trisoup does not need to partition the point cloud into unit cubes with a side length of 1×1×1 step by step, but stops partitioning once there exists a block (sub-block) with a side length of W. Based on a surface formed by the distribution of the point cloud in each block, at most twelve vertices (intersections) generated by the surface and the twelve edges of the block are obtained; surface fitting is performed on the vertices by the surface fitting unit 206; and the geometric encoding is performed on the fitted vertices.

The predictive tree construction unit 207 may encode the position information of the quantized points using a predictive tree encoding manner. For example, the point cloud is partitioned in a prediction tree form, so that the positions of the point in the point cloud may be in one-to-one correspondence with the positions of nodes in the predictive tree. By counting the positions in the prediction tree that have points, the geometry position information of the nodes is predicted by selecting different prediction modes to obtain prediction residuals; and the geometry prediction residuals are quantized using a quantization parameter. Finally, through continuous iteration, the prediction residuals of the predictive tree node position information, the structure of the predictive tree and the quantization parameter are encoded to generate a binary bitstream.

The geometry reconstruct unit 204 may perform position reconstruction based on the position information output by the octree partitioning unit 203 or the vertices fitted by the surface fitting unit 206 to obtain the reconstructed value of the position information of each point in the point cloud data. Alternatively, position reconstruction is performed based on the position information output by the predictive tree construction unit 207 to obtain the reconstructed value of the position information of each point in the point cloud data.

The arithmetic encode unit 205 may perform, by using an entropy coding manner, arithmetic encoding on encode the position information output by the octree partitioning (analyze octree) unit 203 or the vertices fitted by the surface fitting unit 206 or the geometry prediction residual values output by the predictive tree construction unit 207, to generate a geometry bitstream; where the geometry bitstream may also be referred to as a geometry bit stream.

The attribute encoding may be implemented by the following units:
a color transform (transform colors) unit 210, a recoloring (transfer attributes) unit 211, a region adaptive hierarchical transform (RAHT) unit 212, a generate LOD unit 213, a lifting (lifting transform) unit 214, a quantization unit 215, and an arithmetic encode unit 216.

It is to be noted that a point cloud encoder 200 may include more, fewer or different functional components than those illustrated in FIG. 4A.

The color transform unit 210 may be used to transform an RGB color space of the points in the point cloud into a YCbCr format or other formats.

The recoloring unit 211 performs recoloring on color information using the reconstructed geometry information, so that the uncoded attribute information corresponds to the reconstructed geometry information.

After an original value of the attribute information of the point is obtained through transformation by the recoloring unit 211, any one of the transform units may be selected to transform the point in the point cloud. The transform units may include the RAHT transform unit 212 and the lifting (lifting transform) unit 214. The lifting transform depends on generating a level of detail (LOD).

Any one of the RAHT transform and the lifting transform may be understood as being used to predict the attribute information of the point in the point cloud to obtain a prediction value of the attribute information of the point, and then to obtain a residual value of the attribute information of the point based on the prediction value of the attribute information of the point. For example, the residual value of the attribute information of the point may be obtained by subtracting the prediction value of the attribute information of the point from the original value of the attribute information of the point.

In an embodiment of the present disclosure, a process of generating an LOD by the LOD generate unit includes: obtaining Euclidean distances between points according to the position information of the points in the point cloud; and partitioning the points into different detail expression levels according to the Euclidean distances. In an embodiment, after the Euclidean distances are sorted, Euclidean distances in different ranges may be partitioned into different detail expression levels. For example, a point may be randomly selected as a first detail expression level. Then, Euclidean distances between remaining points and the point are calculated, and points whose Euclidean distances meet a first threshold requirement are partitioned as a second detail expression level. A centroid of the points in the second detail expression level is obtained, Euclidean distances between points other than the first and second detail expression levels and the centroid are calculated, and points whose Euclidean distance meet a second threshold are partitioned as a third detail expression level; and so forth, all points are partitioned into the detail expression levels. By adjusting a threshold of Euclidean distance, the number of points in each LOD level may be increased. It is to be understood that the LOD partitioning manner may also be performed using other manners, which is not limited in the present disclosure.

It is to be noted that the point cloud may be directly partitioned into one or more detail expression levels, or the point cloud may be first partitioned into multiple point cloud slices, and then each point cloud slice may be partitioned into one or more LOD levels.

For example, the point cloud may be partitioned into multiple point cloud slices, and the number of points in each point cloud slice may be in a range between 550,000 and 1.1 million. Each point cloud slice may be considered as a separate point cloud. Each point cloud slice may be partitioned into multiple detail expression levels, and each detail expression level includes multiple points. In an embodiment, the detail expression level may be partitioned according to Euclidean distances between the points.

The quantization unit 215 may be used to quantize the residual value of the attribute information of the point. For example, in a case where the quantization unit 215 is connected to the RAHT transform unit 212, the quantization unit 215 may be used to quantize the residual value of the attribute information of the point output by the RAHT transform unit 212.

The arithmetic encode unit 216 may perform entropy encoding on the residual value of the attribute information of the point using zero run length coding, to obtain an attribute bitstream. The attribute bitstream may be bitstream information.

FIG. 4B is a schematic block diagram of a point cloud decoder provided in the embodiments of the present disclosure.

As illustrated in FIG. 4B, the decoder 300 may obtain a point cloud bitstream from an encoding device, and obtain position information and attribute information of a point in the point cloud by parsing the bitstream. Decoding of the point cloud includes position decoding and attribute decoding.

A process of the position decoding includes: performing arithmetic decoding on a geometry bitstream; performing merge after constructing an octree, and reconstructing the position information of the point to obtain reconstructed information of the position information of the point; and performing coordinate transformation on the reconstructed information of the position information of the point to obtain the position information of the point. Position information of a point may also be referred to as geometry information of the point.

A process of the attribute decoding includes: obtaining a residual value of the attribute information of the point in the point cloud by parsing an attribute bitstream; obtaining an inverse-quantized residual value of the attribute information of the point by performing inverse quantization on the residual value of the attribute information of the point; selecting, based on the reconstruction information of the position information of the point obtained in the process of the position decoding, one of the RAHT inverse transform and the lifting inverse transform to perform point cloud prediction to obtain a prediction value, and adding the prediction value to the residual value to obtain a reconstructed value of the attribute information of the point; and performing color space inverse transformation on the reconstructed value of the attribute information of the point to obtain a decoded point cloud.

As illustrated in FIG. 4B, the position decoding may be implemented by the following units:
an arithmetic decoding unit 301, an octree reconstruct (synthesize octree) unit 302, a surface reconstruct (synthesize surface approximation) unit 303, a geometry reconstruct (reconstruct geometry) unit 304, a coordinate inverse transform (inverse transform coordinates) unit 305 and a predictive tree reconstruct unit 306.

The attribute decoding may be implemented by the following units:
an arithmetic decoding unit 310, an inverse quantize unit 311, an RAHT inverse transform unit 312, a generate LOD unit 313, an inverse transform (inverse lifting) unit 314, and a color inverse transform (inverse transform colors) unit 315.

It should be noted that decompression is an inverse process of compression. Similarly, as for functions of all units in the decoder 300, reference may be made to the functions of the corresponding units in the encoder 200. In addition, the point cloud decoder 300 may include more, fewer, or different functional components than those illustrated in FIG. 4B.

For example, the decoder 300 may partition the point cloud into multiple LODs based on Euclidean distances between points in the point cloud, and decode attribute information of the points in the LODs in turn, e.g., compute the number of zeros (zero_cnt) in a zero-run encoding technique to decode a residual based on zero_cnt. Then, a decoding architecture may perform inverse quantization based on the decoded residual value, and obtain a reconstructed value of the point cloud by adding an inverse-quantized residual value to a prediction value of a current point, until all point clouds are decoded. The current point will serve as the nearest neighbor point to points in a subsequent LOD, and attribute information of the subsequent points will be predicted using the reconstructed value of the current point.

The above is a basic process of the point cloud encoder and decoder based on the GPCC encoding and decoding architecture. With the development of technology, some modules or steps of the architecture or process may be optimized. The present disclosure is applicable to the basic process of the point cloud encoder and decoder based on the GPCC encoding and decoding architecture, but is not limited to the architecture and process.

Next, the octree-based geometric encoding and the prediction tree-based geometric encoding are introduced below.

The octree-based geometric encoding includes the following steps. First, coordinate transform is performed on the geometry information, so that all point clouds are included in a Bounding Box. Then, quantization is performed, and the process of quantization mainly plays the role of scaling. Due to quantization and rounding, the geometry information of part of points is the same, it is determined whether to remove duplicate points based on parameters, and the process of quantization and removal of duplicate points is also referred to as voxelization process. Next, tree partitioning (e.g., octree, quadtree, binary tree) is performed on the Bounding Box continually in the order of breadth-first traversal, and the occupancy code of each node is encoded. In an implicit geometry partitioning method. First, the bounding box of the point cloud (2^{d}^{ₓ}, 2^{d}^{_{y}}, 2^{d}^{ₓ}) is calculated; and assuming that dₓ, d_{y}>d_{z}, the bounding box corresponds to a cuboid. During geometry partitioning, binary tree partitioning is performed first based on the x-axis to obtain two child nodes; binary tree partitioning continues until the condition of dₓ=d_{y}>d_{z} is met, quadtree partitioning is performed continually based on the x and y axes to obtain four child nodes; and then, when the condition of dₓ=d_{y}=d_{z} is met, octree partitioning is performed continually until the leaf node obtained through partitioning is a unit cube with a size of 1×1×1, at which the partitioning operation terminates. After that, the points in the leaf nodes are encoded to generate a binary bitstream. During the process of binary tree/quadtree/octree-based partitioning, two parameters, K and M, are introduced. Parameter K indicates the maximum number of binary tree/quadtree partitionings before octree partitioning is performed; and parameter M is used to indicate that the side length of the corresponding minimum block is 2^{M} when binary tree/quadtree partitioning is performed. At the same time, K and M must meet the condition: assuming that dₘₐₓ=max(dₓ, d_{y}, d_{z}), dₘᵢₙ=min(dₓ, d_{y}, d_{z}), parameter K meets the condition of K>=dₘₐₓ−dₘᵢₙ; and parameter M meets the condition of M>=dₘᵢₙ. The reason why parameters K and M meet the above conditions is that, during the current process of G-PCC geometry implicit partitioning, the priority of the partitioning manners is binary tree, quadtree and octree. Only when the block size of the node does not meet the condition of binary tree/quadtree, octree partitioning will be performed on the node until the minimum unit of the partitioned leaf node has a size of 1×1×1.

The octree-based geometry information encoding mode may effectively encode the geometry information of the point cloud by utilizing the correlation between neighboring points in space. However, for some relatively planar nodes or nodes with planar characteristics, the coding efficiency of the geometry information of point cloud may be further improved by utilizing the planar coding.

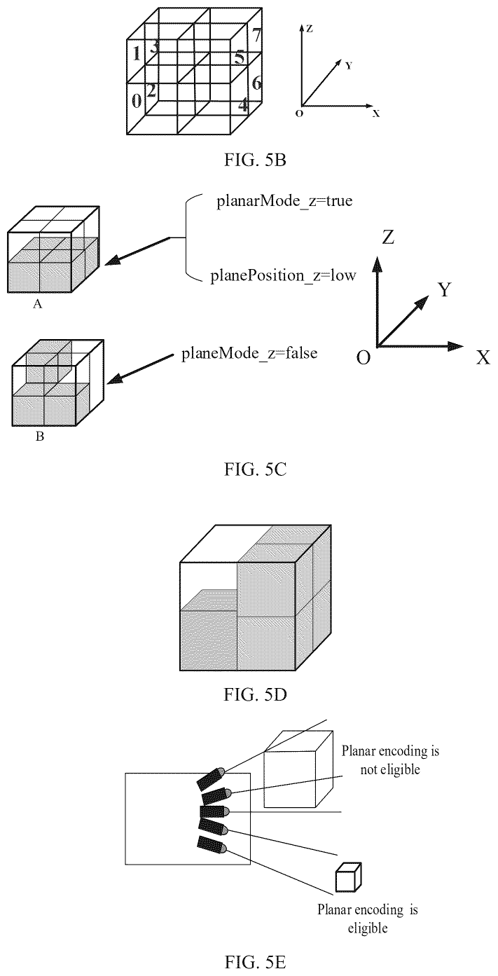

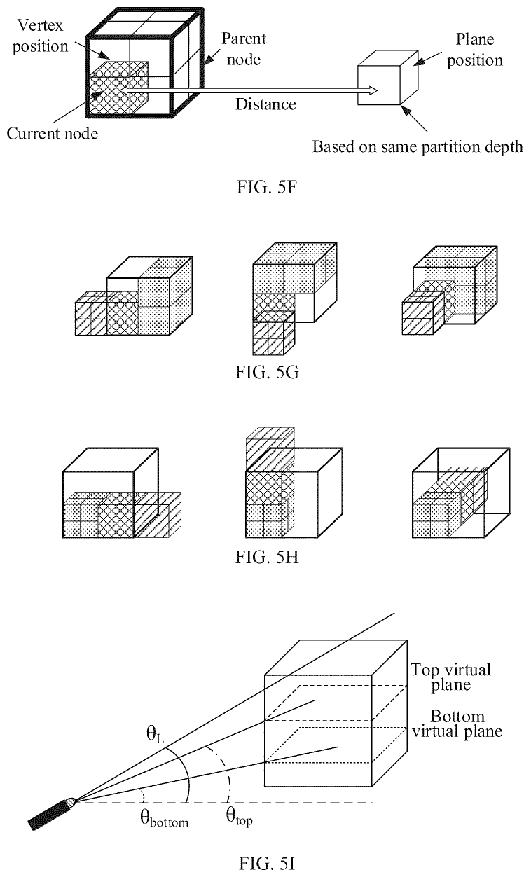

For example, as illustrated in FIG. 5A, (A) series belongs to a low plane position in a Z-axis direction, and (B) series belongs to a high plane position in the Z-axis direction. Taking (A) as an example, it can be seen that the four occupied child nodes of the current node are all located in the low plane positions of the current node in the Z-axis direction. Therefore, it may be considered that the current node belongs to a Z plane and is a low plane in the Z-axis direction. Similarly, (B) indicates that the occupied child nodes of the current node are located in the high plane positions of the current node in the Z-axis direction . . .

Taking (A) as an example, the octree encoding and the planar encoding are compared in terms of efficiency. As illustrated in FIG. 5B, if an octree encoding manner is used for (A) in FIG. 5A, occupancy information of the current node is represented as: 11001100. Whereas if a planar encoding manner is used, first, an identifier needs to be encoded to represent that the current node is a plane in the Z axis direction; second, if the current node is a plane in the Z axis direction, the planar position of the current node needs to be represented; and then only occupancy information of low planar nodes in the Z axis direction needs to be encoded (e.g., occupancy information of four child nodes 0246). Therefore, based on the planar encoding manner, only 6 bits are needed to encode the current node, which may reduce 2 bits of representation compared to the original octree encoding. Based on this analysis, the planar encoding has more significant encoding efficiency than the octree encoding. Therefore, for an occupied node, if the planar coding is used for encoding in a certain dimension, as illustrated in FIG. 5C, first, planar flag (planarMode) information and planar position (PlanePos) information of the current node in this dimension need to be represented, and then occupancy information of the current node is encoded based on planar information of the current node. It will be noted that: for PlaneModei (i is equal to 0, 1 or 2): 0 represents that the current node is not a plane in an i-axis direction. In a case where the node is a plane in the i-axis direction, for PlanePositioni: 0 represents that the current node is a plane in the i-axis direction, and its planar position is a low plane, 1 represents that the current node is a high plane in the i-axis direction. For example, i=0 represents the X axis, i=1 represents the Y axis, and i=2 represents the Z axis.

In the current GPCC standard, a determination of whether a node meets conditions for the planar encoding, and predictive encoding of planar flag and planar position information of the node in a case where the current node meets the conditions for the planar encoding, are introduced in detail below.

In the current G-PCC standards, there are three types of determination condition for determining whether a node meets planar coding, which are described in detail below.

The first type: the determination is performed according to a plane probability of the node in each dimension.

First, a local node density (local_node_density) of the current node and a probability of the current node Prob (i) in each dimension are determined.

When the local_node_density of the node is less than a threshold Th (Th=3), the plane probabilities of the current node in three coordinate dimensions Prob (i) are compared with thresholds Th0, Th1 and Th2, where Th0<Th1<Th2 (Th0=0.6, Th1=0.77 and Th2=0.88). Hereafter, Eligible; (i=0, 1, 2) is used to represent whether the planar coding is enabled in each dimension, the determination process of Eligible; is shown in formula (1). For example, if Eligiblei>=threshold, it indicates that planar coding is enabled in the i-th dimension:

$${Eligible}_{i} = Prob ( i ) >= threshold \qquad ( 1 )$$

It is to be noted that the threshold is adaptively changed. For example, when Prob (1) is greater than Prob (0) and less than Prob (2) (i.e., Prob (0)>Prob (1)>Prob (2)), a value of the threshold is as shown in formula (2):

$${Eligible}_{0} = Prob ( 0 ) >= Th 0 \qquad ( 2 )$$

$${Eligible}_{1} = Prob ( 1 ) >= Th 1$$

$${Eligible}_{2} = Prob ( 2 ) >= Th 2$$

The update process of local_node_density and the updating of Prob(i) are described below.

In an example, Prob (i) is updated as the following formula (3):

$$Prob {( i )}_{new} = ( Lx Prob ( i ) + δ ( coded node ) ) / L + 1 \qquad ( 3 )$$

Where L is equal to 255 (L=255), and δ(coded node) is 1 when the coded node is a plane, otherwise, δ(coded node) is 0.

In an example, local_node_density is updated as the following formula (4):

$$local\_node {\_density}_{new} = local\_node \_density + 4 * numSiblings \qquad ( 4 )$$

Where local_node_density is initialized to 4, and numSiblings is the number of sibling nodes of the node. As illustrated in FIG. 5D, in a case where the current node is a left node and the right nodes are siblings of the current node, the number of the siblings of the current node is 5 (including the current node itself).

The second type: it is determined whether the nodes in the current level (or referred to as layer) meet planar coding according to the point cloud density of the current level.

The density of points in the current level is used to determine whether to perform planar coding on the nodes in the current level. Assuming that the number of points in the current to-be-encoded point cloud is pointCount, and the number of points reconstructed after IDCM encoding is numPointCountRecon. Because octree coding is performed based on the order of breadth-first traversal, the number of nodes to be encoded in the current level is assumed to be nodeCount; and then the determination of whether planar coding is enabled on the current level is assumed to be planarEligibleKOctreeDepth. Where the determination process of planarEligibleKOctreeDepth is shown in formula (5):

$$planarEligibleKOctreeDepth = ( pointCount - numPointCountRecon ) < nodeCount * 1.3 \qquad ( 5 )$$

When planarEligibleKOctreeDepth is true, planar coding is performed on all nodes in the current level; otherwise, planar coding is not performed on all nodes in the current level, and octree coding is adopted only.

The third type: it is determined whether the current node meets planar coding according to a collection parameter of a laser radar point cloud.

As illustrated in FIG. 5E, it may be seen that a node of large cube at top is passed through by two lasers simultaneously, so the current node is not a plane in a direction perpendicular to the Z axis, and a node of small cube at bottom is small enough that it cannot be passed through by two nodes simultaneously, so the current node is likely to be a plane. Therefore, whether the current node meets the planar encoding is determined based on the number of lasers corresponding to the current node.

For a node meeting the condition for planar coding, predictive coding on the planar flag information and the plane position information are introduced below.

I. Predictive coding of the planar flag information.

At present, the planar flag information is encoded using three contexts. That is, the context is designed separately for planar representations in each dimension.

Encoding of planar position information of non-lidar point clouds and encoding of planar position information of laser radar point clouds are introduced separately below.

### I. Encoding of the Planar Position Information of the Non-Lidar Point Clouds

### 1. Predictive Coding of the Plane Position Information

The predictive coding is performed on the plane position information based on the following information:
(1) the plane position information of the current node obtained by using the occupancy information of neighborhood nodes for prediction, the plane position information being three elements: predicted as a low plane, predicted as a high plane or unpredictable;
(2) the spatial distance between a node at the same partitioning depth and the same coordinate as the current node and the current node: “near” or “far”;
(3) a planar position of a node at the same partition depth and the same coordinate as the current node; and
(4) coordinate dimension (i=0, 1, 2).

As illustrated in FIG. 5F, the current node to be encoded is a left node, a neighborhood node is searched for as a right node at the same octree partition depth level and the same vertical coordinate, a distance between those two nodes is determined as “near” or “far”, with reference to the planar position of the node.

In an example, as illustrated in FIG. 5G, a node filled with gridding is the current node; and if the current node is located at a low plane of a parent node, the planar position of the current node is determined in manners as follows.
a) If any one of child nodes 4 to 7 of a node filled with slashes is occupied, and all nodes filled with points are not occupied, there is a high probability that there is a plane in the current node, and the plane position is located lower.
b) If none of the child nodes 4 to 7 of the node filled with slashes is occupied, and any node filled with points are occupied, there is a high probability that there is a plane in the current node, and the plane position is located higher.
c) If all the child nodes 4 to 7 of the node filled with slashes are empty nodes, and all the nodes filled with points are empty nodes, the plane position cannot be inferred and is therefore marked as unknown.
d) If any one of the child nodes 4 to 7 of the node filled with slashes is occupied, and any one of the nodes filled with points is occupied, the plane position still cannot be inferred and is therefore marked as unknown.

In another example, as illustrated in FIG. 5H, a node filled with gridding is the current node; and if the current node is located at a high planar position of a parent node, the planar position of the current node is determined in manners as follows.
a) If any one of child nodes 4 to 7 of a node filled with points is occupied, and a node filled with slashes is not occupied, there is a high probability that there is a plane in the current node, and the plane position is located lower.
b) If the child nodes 4 to 7 of the node filled with points are not occupied, and the node filled with slashes is occupied, there is a high probability that there is a plane in the current node, and the plane position is located higher.
c) If all the child nodes 4 to 7 of the node filled with points are not occupied, and the node filled with slashes is not occupied, the plane position cannot be inferred and is therefore marked as unknown.
d) If any one of the child nodes 4 to 7 of the node filled with points is occupied, and the node filled with slashes is occupied, the plane position cannot be inferred and is therefore marked as unknown.

### II. Encoding of the Planar Position Information of Laser Radar Point Clouds

FIG. 5I illustrates the predictive encoding of the planar position information of the laser radar point cloud. The planar position of the current node is predicted by using parameters collected by a laser radar, and the position is quantized into four intervals by using positions of intersection of the current node and laser rays, which finally serve as the context of the planar position of the current node. A specific calculation process is the following: assuming that coordinates of the laser radar are (x_{Lidar}, y_{Lidar}, z_{Lidar}) and geometric coordinates of the current point are (x, y, z), a vertical tangent value tan [symbol] θ of the current point relative to the laser radar is first calculated, with the calculation process shown in formula (6):

$$tan θ = \frac{z - {z}_{Lidar}}{\sqrt{{( x - {x}_{Lidar} )}^{2} + {( y - {y}_{Lidar} )}^{2}}} \qquad ( 6 )$$

In addition, since each laser has a certain offset angle relative to the laser radar, a relative tangent value tan θ_{corr,L} of the current node relative to the laser is calculated, with the specific calculation process shown in formula (7):

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 7 )$$

Finally, the planar position of the current node is predicted by using a corrected tangent value of the current node. Exemplarily, assuming that a tangent value of a lower boundary of the current node is tan (θ bottom), and a tangent value of an upper boundary is tan (θ top), the planar position is quantized into 4 quantization intervals based on tan θ_{corr,L}, i.e., the context of the planar position.

However, the octree-based geometry information encoding mode only has an efficient compression rate for points that are correlated in space. For points that are isolated in the geometric space, use of the direct coding model (DCM) may greatly reduce complexity. For all nodes in the octree, use of DCM is not represented by flag information, but is inferred from the parent node and neighboring information of the current node. There are three manners to determine whether the current node is eligible for the DCM encoding, as illustrated in FIG. 6.
(1) The current node has no sibling child nodes, that is, the parent node of the current node has only one child node, and the parent node of the parent node of the current node has only two occupied child nodes, that is, the current node has at most one neighboring node.
(2) The parent node of the current node has only one occupied child node (i.e., the current node); and the six neighboring nodes that share a face with the current node also belong to empty nodes.
(3) The number of sibling nodes of the current node is greater than 1.

If the current node is not eligible for DCM encoding, octree partitioning will be performed on the current node. If the current node is eligible for DCM encoding, the number of points included in the node will be further determined. When the number of points is less than a threshold (e.g., 2), DCM encoding will be performed on the node, otherwise, octree partitioning will continue to be performed on the node. When the DCM coding mode is applied, it is necessary to encode whether the current node is a real isolated point firstly, i.e., IDCM_flag. When IDCM_flag is true, the current node adopts DCM encoding, otherwise, it is still adopts octree coding. When the current node meets the condition for DCM encoding, it is necessary to encode the DCM coding mode of the current node. At present, there are two DCM modes, which are: (1) existing only one point (or multiple points, but they are duplicate points); and (2) containing two points. Finally, it is necessary to encode the geometry information of each point. Assuming that a side length of the node is 2^{d}, d bits are required to encode each component of the geometry coordinates of the node, and this bit information is directly encoded into the bitstream. It is to be noted here that when encoding is performed on the laser radar point cloud, predictive coding is performed on the coordinate information with three dimensions by using the laser radar acquisition parameters, thereby further improving the coding efficiency of the geometry information.

It is also to be noted that when a node is partitioned into leaf nodes, under geometry lossless encoding, the number of duplicate points in the leaf nodes needs to be encoded. Finally, the occupancy information of all nodes is encoded to generate a binary bitstream. In addition, a planar coding mode is introduced in G-PCC currently. During the process of geometry partitioning, it will be determined whether the child nodes of the current node are co-planar. If the child nodes of the current node meet the condition for co-planar, the child nodes of the current node will be represented by the plane.

For the octree-based geometric decoding, before decoding the occupancy information of each node, a decoding side (or referred to as decoder) will first determine, in the order of breadth-first traversal, whether to perform the planar decoding or the IDCM decoding on the current node by using the reconstructed geometry information. If the current node meets a condition for the planar decoding, the decoding side will first decode the planar flag and planar position information of the current node, and then decode the occupancy information of the current node based on the planar information. If the current node meets a condition for the IDCM decoding, the decoding side will first decode whether the current node is a true IDCM node; and if the current node is a true IDCM node, the decoding side will continue to parse the DCM decoding mode of the current node, and then the decoding side may obtain the number of points in the current DCM node and finally decode the geometry information of each point. For a node that does not meet either the planar decoding or the DCM decoding, the occupancy information of the current node will be decoded. By continuously parsing in this manner, an occupancy code of each node is obtained, and the partitioning is continued for the nodes in turn until unit cubes of 1×1×1 are obtained. The number of points included in each leaf node is parsed, and geometric reconstruction point cloud information is restored finally.

In a geometry information encoding architecture based on trisoup (triangle soup), similarly, geometric partitioning is also performed first. However, unlike the binary tree/quadtree/octree-based geometry information encoding, this method does not need to partition the point cloud into unit cubes with side lengths of 1×1×1 step by step, but stops partitioning once there exist blocks (sub-blocks) with a side length of W. Based on a surface formed in each block by the distribution of the point cloud, at most twelve vertices (intersections) generated by this surface and twelve sides of the block are obtained. Vertex coordinates of each block are encoded in turn to generate a binary bitstream.

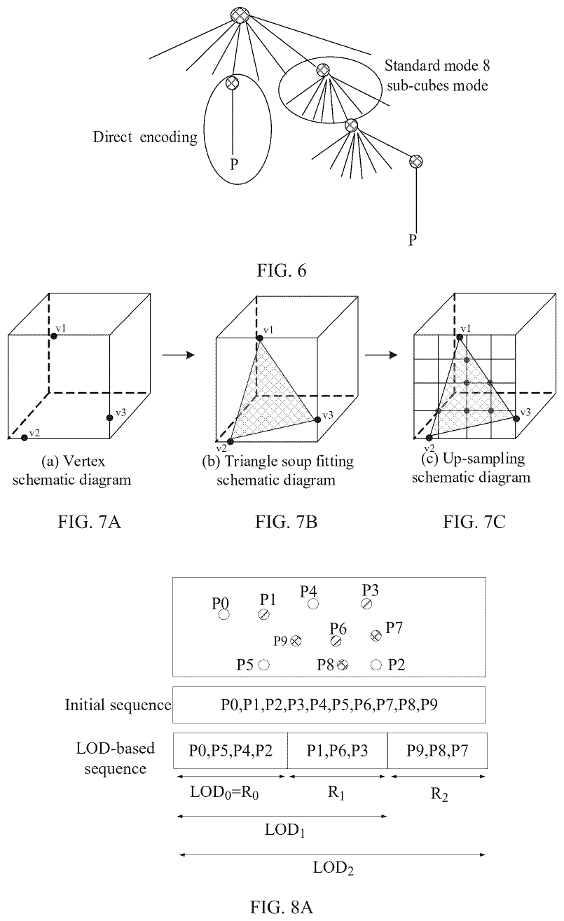

For trisoup-based point cloud geometry information reconstruction, in response to performing the point cloud geometry information reconstruction, the decoding side first decodes the vertex coordinates to complete triangle soup reconstruction, a process of which is illustrated in FIG. 7A to FIG. 7C. There are three vertices (v1, v2, v3) in a block illustrated in FIG. 7A, and the triangle soup, i.e., trisoup, formed by these three vertices in a certain order is illustrated in FIG. 7B. Afterwards, sampling is performed on the triangle soup to obtain sampling points, which will serve as a reconstructed point cloud within the block, as illustrated in FIG. 7C.

The predictive tree-based geometric encoding includes steps as follows. First, an input point cloud is sorted, and the sorting methods currently used include unordered, Morton order, azimuth order, and radial distance order. An encoding side (or referred to as encoder) establishes a prediction tree structure by using two different manners including a high-latency slow mode (KD-Tree), and a low-latency fast mode in which each point is assigned to a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream.

For the predictive tree-based geometry decoding, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometry information is reconstructed after the geometric encoding is completed. Currently, attribute encoding is mainly performed on color information. First, the color information is transformed from an RGB color space to a YUV color space. The point cloud is then recolored by using the reconstructed geometry information, to enable unencoded attribute information to correspond to the reconstructed geometry information. In color information encoding, there are two main transformation manners: one is distance-based lifting transformation that relies on LOD (level of detail) partitioning, and the other is that RAHT (Region Adaptive Hierarchal Transform) transformation is performed directly. Both manners can transform the color information from a spatial domain to a frequency domain, a high-frequency coefficient and a low-frequency coefficient are obtained through the transformation, and finally the coefficients are quantized and encoded to generate a binary bitstream.

When the attribute information is predicted by using the geometry information, Morton code may be used for performing nearest neighbor search, where the Morton code corresponding to each point in the point cloud may be obtained from geometric coordinates of this point. A specific method for calculating the Morton code is described below. For a three-dimensional coordinate with each component represented by a d-bit binary value, its three components may be represented as formula (8):

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} , \qquad ( 8 )$$

Where [symbol] ∈{0,1} are binary values corresponding to bits, from the highest ( [symbol] =1) to the lowest ( [symbol] =d), of x, y, z, respectively. For x, y, z, starting from the highest bit, [symbol] are crosswise arranged in e-quaintance by using the Morton code M up to the lowest bit. Calculation formula of M is shown in formula (9):

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} ; \qquad ( 9 )$$

Where [symbol] ∈{0, 1} are values of M from the highest bit ( [symbol] =1) to the lowest bit ( [symbol] =3d). After the Morton code M of each point in the point cloud is obtained, the points in the point cloud are arranged in order of Morton code in an ascending order, and a weight value w of each point is set to 1.

There are 4 general test conditions for GPCC:
Condition 1: geometry positions with limited loss, and attributes with loss;
Condition 2: geometry positions lossless, but attributes with loss;
Condition 3: geometry positions lossless, and attributes with limited loss; and
Condition 4: geometry positions lossless, and attributes lossless.

The general test sequence includes four categories: Cat1A, Cat1B, Cat3-fused and Cat3-frame. Cat3-frame point cloud only includes reflectance attribute information, Cat1A and Cat1B point clouds only include color attribute information, and Cat3-fused point cloud includes both color and reflectance attribute information.

There are two technical routes for GPCC, which are distinguished by the algorithm used for geometry compression and classified into an octree coding branch and a predictive tree coding branch.

In the octree coding branch, at the encoding side, a bounding box is continuously partitioned into sub-cubes; and partitioning is continued for non-empty sub-cubes (including points in the point cloud) until leaf nodes obtained by partitioning are unit cubes of 1×1×1. In a case of geometric lossless encoding, the number of points included in the leaf node needs to be encoded to finally complete the encoding of the geometric octree and generate the binary bitstream. At the decoding side, the decoding side obtains, in the order of breadth-first traversal, an occupancy code of each node by continuous parsing, and the partitioning is continued for the nodes in turn until unit cubes of 1×1×1 are obtained. In the case of the geometric lossless decoding, the number of points included in each leaf node needs to be parsed, and the geometric reconstruction point cloud information is restored finally.

In the predictive tree coding branch, at the encoding side, a prediction tree structure is established by using two different manners including a high-latency slow mode (KD-Tree), and a low-latency fast mode in which each point is assigned into a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream. At the decoding side, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometric encoding and decoding under the G-PCC coding framework arc introduced above. The attribute encoding and decoding under the G-PCC coding framework are introduced below.

As illustrated in FIG. 4A, the current G-PCC coding framework includes three attribute encoding methods: predicting transform (PT), lifting transform (LT), and region adaptive hierarchical transform (RAHT). The first two methods perform predictive encoding on the point cloud based on the generation order of LODs, and the RAHT adaptively transforms attribute information from bottom to top based on the construction hierarchy of the octree. These three point cloud attribute encoding methods are explained separately below.

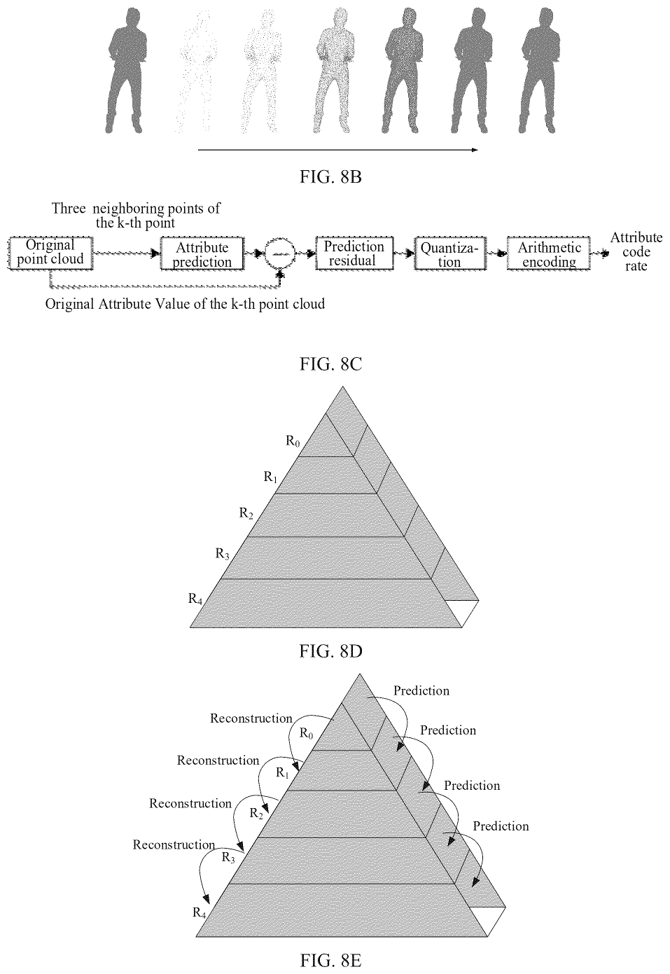

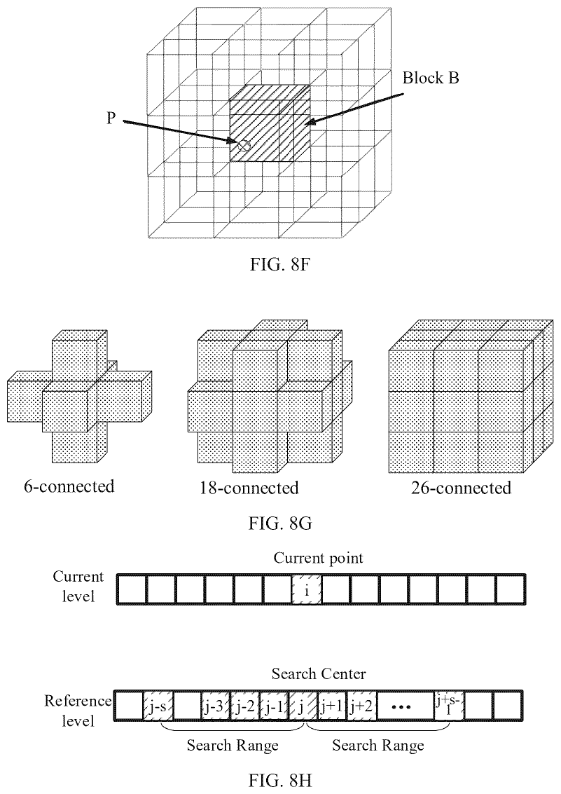

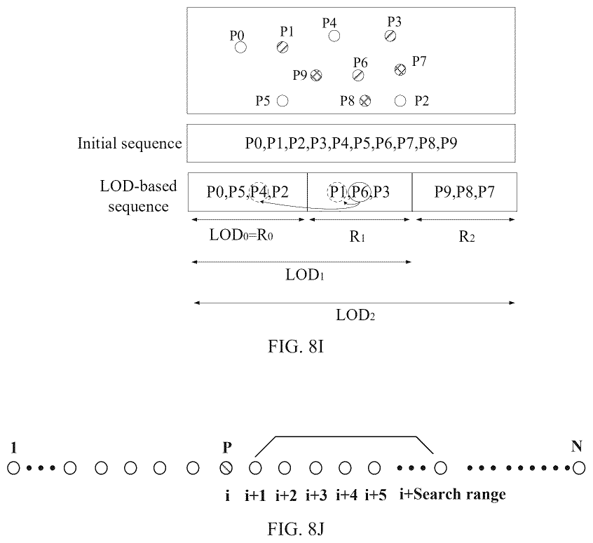

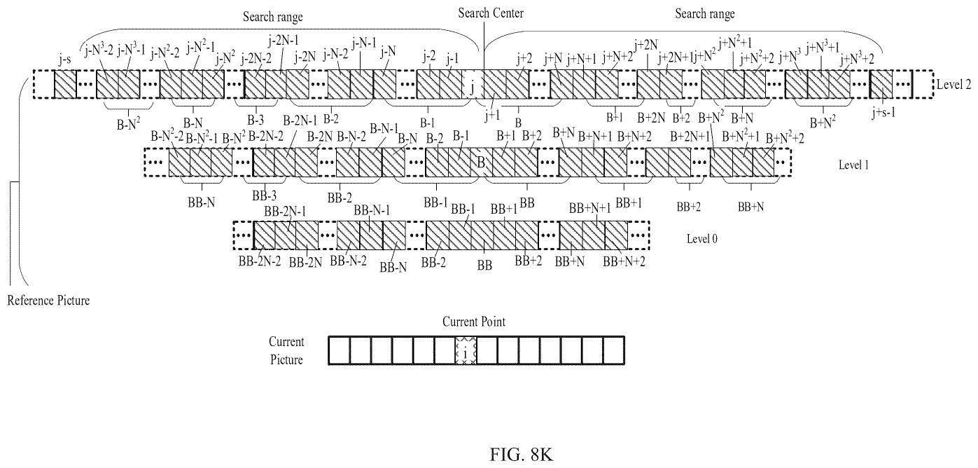

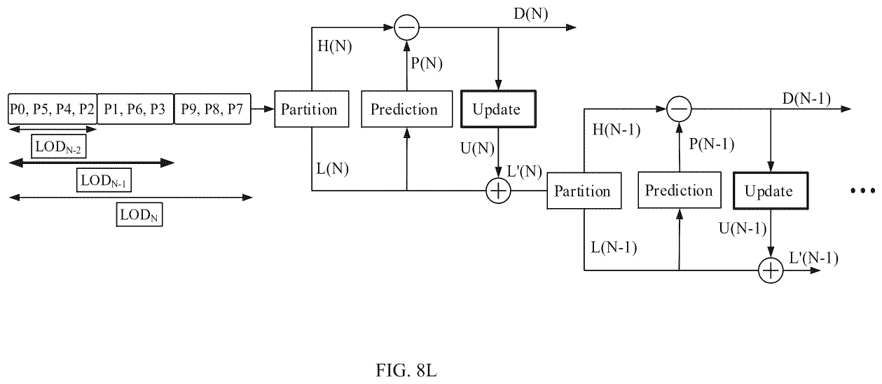

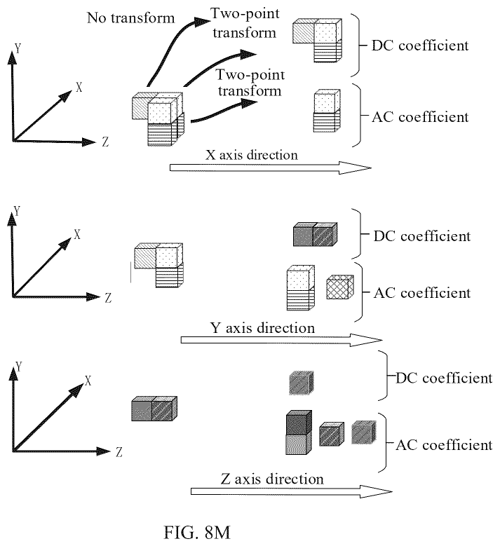

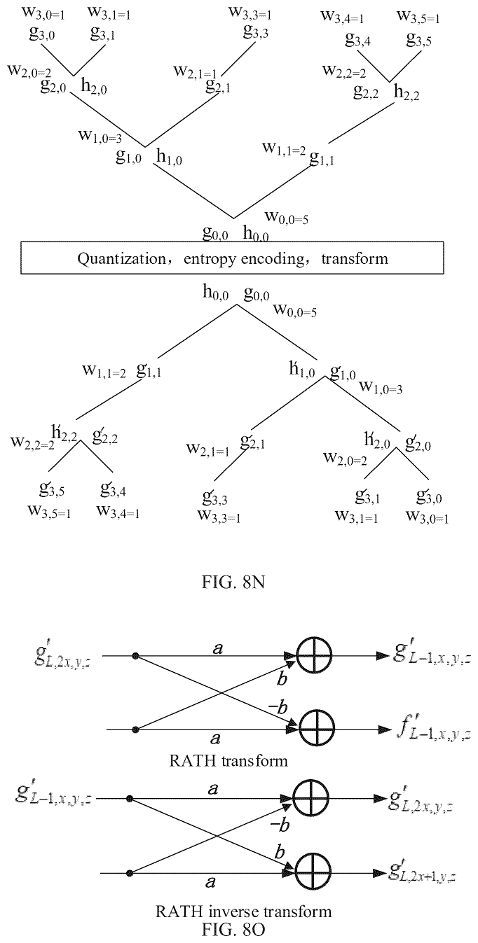

At present, the attribute prediction module of G-PCC uses a nearest neighbor attribute prediction encoding scheme based on a level-of-details (LoDs) structure. The LOD construction methods include a distance-based LOD construction scheme, a fixed sampling rate-based LOD construction scheme, and an octree-based LOD construction scheme. In the LOD construction scheme based on a distance threshold, the point cloud is first Morton sorted before constructing LOD to ensure that there is a strong attribute correlation between neighboring points. As illustrated in FIG. 8A, an example of a distance-based LOD construction process is given, in which the point clouds are partitioned into L different point cloud levels of detail (Rl) l=0,1, . . . . L−1 based on L Manhattan distances (dl) l=0,1, . . . . L−1 preset by the user, where (dl) l=0,1, . . . . L−1 meets dl less than dl−1. The construction process of LOD is as follows. (1) First, all points in the point cloud are marked as unvisited, and a set V is established to store the visited point set. (2) For each iteration 1, by traversing the points in the point cloud, if the current point has been visited, the current point is skipped, otherwise the minimum distance D from the current point to the point set V is calculated, if D less than dl, the point is skipped; otherwise, the current point is marked as visited, and the current point is added to the levels of detail Rl and the point set V. (3) The points in the level of detail LODl are composed of the points in the levels of detail R0, R1, R2 . . . . Rl; (4) The above steps are repeated until all points have been marked as visited.

Based on the LOD structure, the attribute value of each point is linearly weighted predicted by using the reconstructed attribute value of the point in the same or higher LOD level, where the maximum number of reference prediction neighbors is determined based on the encoder high-level syntax elements. For the attributes of each point, the rate-distortion optimization algorithm is used at the encoding side to select weighted prediction by using the attributes of the N nearest neighbor points searched or selecting the attributes of a single nearest neighbor point for prediction, and finally the selected prediction mode and prediction residual are encoded.

For example, the attribute prediction value is determined based on the following formula (10):

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 10 )$$

Where N represents the number of prediction points in the nearest neighbor point set of point i, Pᵢ represents a sum of the N nearest neighbor points of point i, Dₘ represents a spatial geometry distance from the nearest neighbor point m to the current point i, Attrₘ represents the attribute value of the nearest neighbor point m after reconstruction, Attrᵢ′ represents the attribute prediction value of the current point i, and the number of points N is a preset value.

In order to balance the attribute encoding efficiency and parallel processing between different LOD levels, a switch is introduced in the encoder high-level syntax element to control whether to introduce intra-LOD level prediction. If the switch is turned on, intra-LOD level prediction is started, and points in the same LOD level may be used for prediction. It should be noted that in a case where the number of LOD levels is 1, intra-LOD level prediction is always used.

In an example, FIG. 8B illustrates a visualization result of LOD. The points at the first level represent outer contours of the point cloud. As the number of levels of LOD increases, the detail description of the point cloud becomes clearer.

In an example, FIG. 8C illustrates a flowchart of G-PCC attribute prediction. That is, for the k-th point in the point cloud, three neighboring points of the k-th point are first determined, and an attribute prediction value of the k-th point is determined based on the attribute reconstructed information of the three neighboring points. Next, an attribute prediction residual of the k-th point is obtained based on an original attribute value and the attribute prediction value of the k-th point, and after the attribute prediction residual is quantized, arithmetic encoding is performed to obtain an attribute bitstream.

In some embodiments, after the LOD is constructed, the three nearest neighbor points of the current point to be encoded are first found from the encoded data points based on the generation order of the LOD. The attribute reconstructed values of the three nearest neighbor points are used as candidate prediction values of the current point to be encoded; then, the optimal prediction value is selected from the attribute reconstructed values of the three nearest neighbor points according to the rate-distortion optimization (RDO). For example, in a case of encoding the attribute value of point P2 in FIG. 8A, the predictor variable index of the attribute value of the nearest neighbor point P4 is set to 1; the attribute predictor variable indexes of the second neighboring point P5 and the third neighboring point P0 are set to 2 and 3 respectively; and the predictor variable index of the weighted average of points P0, P5 and P4 is set to 0, as shown in Table 2:

TABLE 2
Samples of candidate prediction items for attribute encoding

| Prediction mode | Prediction value |
|---|---|
| 0 | Weighted average of attributes of three neighbors |
| 1 | P4 (an attribute value of the first neighbor) |
| 2 | P5 (an attribute value of the second neighbor) |
| 3 | P0 (an attribute value of the third neighbor) |

Finally, the optimal predictor variable is selected using RDO. The formula of weighted average is shown in formula (11):

$${\hat{a}}_{i} = ( {\sum }_{j = 0}^{2} \frac{{\tilde{w}}_{ij}}{{\sum }_{j = 0}^{2} {\tilde{w}}_{ij}} {ã}_{j} ) \qquad ( 11 )$$

In formula (11), \tilde{w}ᵢⱼ represents the spatial geometric weight from the neighboring point j to the current point i, and the calculation formula is shown in formula (12):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 12 )$$

Where âᵢ represents the attribute prediction value of the current point i, j represents the indexes of the three neighboring points, ãⱼ represents the attribute value of the nearest-neighbor points after reconstruction, xᵢ, yᵢ, zᵢ are the geometry position coordinates of the current point i, and xᵢⱼ, yᵢⱼ, zᵢⱼ are the geometry coordinates of the neighboring points j.

The attribute prediction residual and quantification are introduced below.

Through the above prediction, the attribute prediction value (âᵢ)_{i∈0 . . . k-1} (where k represents a total number of points in the point cloud) of the current point i is obtained. Let (aᵢ)_{i∈0 . . . k-1} be the original attribute value of the current point, then as shown in formula (13), the attribute residual (rᵢ)_{i∈0 . . . k-1} is denoted as:

$${r}_{i} = {a}_{i} - {\hat{a}}_{i} \qquad ( 13 )$$

Furthermore, the prediction residual is quantified based on the following formula (14):

$${Q}_{i} = \frac{{r}_{i}}{Qs} \qquad ( 14 )$$

In formula (14), Qᵢ represents the quantized attribute residual of the current point i, and Qs represents the quantization step, which may be calculated by the quantization parameter (QP) specified by CTC.

### Reconstruction of the Attribute Value at the Encoding Side

The purpose of reconstruction at the encoding side is to predict subsequent points. Before the reconstruction of the attribute value, the residual needs to undergo inverse quantization, as shown in formula (15), \hat{r}ᵢ is denoted as the residual after inverse quantization:

$$\begin{matrix}{\hat{r}}_{i} = {Q}_{i} \times Qs & {\hat{r}}_{i} = {Q}_{i} \times Qs\end{matrix} \qquad ( 15 )$$

Then, based on the following formula (16), the reconstructed value ãᵢ of the point i is obtained by adding \hat{r}ᵢ to the prediction value âᵢ:

$${\tilde{a}}_{i} = {\hat{r}}_{i} + {\hat{a}}_{i} \qquad ( 16 )$$

When performing attribute nearest neighbor search based on LOD partition, there are currently two major types of algorithms: intra nearest neighbor search and inter nearest neighbor search. The intra nearest neighbor search is divided into two algorithms: inter-level nearest neighbor search and intra-level nearest neighbor search.

### Intra Nearest Neighbor Search

The intra nearest neighbor search is divided into two algorithms: inter-level nearest neighbor search and intra-level nearest neighbor search. After LOD partition, a pyramid structure similar to that illustrated in FIG. 8D is obtained.

### 1. Inter-Level Nearest Neighbor Search

As illustrated in FIG. 8E and FIG. 8A, different LOD levels, namely LOD0, LOD1 and LOD2, are obtained based on the geometry information partitioning, and points in LOD0 are used to predict attributes of points in a next LOD during the process of the inter-level nearest neighbor search.

The entire process of the intra nearest neighbor search is described in detail below.

In the entire process of LOD partition, there are three sets O(k), L(k) and I(k), where k is the index of the LOD level during LOD partition, and I(k) is the input point set during the current LOD level partition. After LOD level partition, O(k) and L(k) sets are obtained. The O(k) set stores the sampling point set, and L(k) is the point set in the current LOD level. That is, the entire process of LOD partitioning is as follows.
(1) Initialization

$$if k = 0 , ( k ) ← \{ \} . Otherwise ( k ) ← L ( k - 1 )$$

$$O ( k ) ← \{ \}$$

(2) Based on the LOD partition algorithm, the sampling points are stored in (k), and the remaining points are partitioned into (k).
(3) In a case of performing the next iteration, I←(k).

It is to be noted here that since the entire process of LOD partition is based on the Morton code, O(k), L(k) and I(k) store the Morton code index corresponding to the point.

When performing inter-level nearest neighbor search, that is, the points in the L(k) set performing nearest neighbor search in the O(k) set, the specific search algorithm is as follows.

### Nearest Neighbor Search is Performed Based on Spatial Relationships

When predicting the current point P, neighbor search is performed by using the parent block (Block B) corresponding to the point P, as illustrated in FIG. 8F, to search for points in neighbor blocks that are co-planar or co-edge with the current parent block to perform attribute prediction.

For example, the spatial relationship of co-plane, co-edge and co-vertex is illustrated in FIG. 8G.

First, the coordinates of the current point are used to obtain a corresponding spatial block. Secondly, the nearest neighbor search is performed in the previously encoded LOD to find spatial blocks that are co-planar, co-edged, and co-pointed with the current block to obtain the N neighbors of the current point.

If the N neighbors of the current point are still not obtained after performing co-planar, co-edge and co-vertex nearest neighbor searches, the N neighbors of the current point will be obtained based on a fast search algorithm, and the specific algorithm is illustrated in FIG. 8H. When performing inter-attribute level prediction, the Morton code corresponding to the current point is first obtained using the geometric coordinates of the current point to be encoded. Secondly, based on the Morton code of the current point, the reference point (j) whose Morton code is a first one greater than the Morton code of the current point is found in the reference picture. Then, the nearest neighbor search is performed in the range of [j−searchRange, j+searchRange].

The rest of the specific algorithms for updating the nearest neighbor are the same as the inter nearest neighbor search algorithm, which will not be repeated here. The specific algorithms will be mentioned in the inter nearest neighbor search algorithm.

### 2. Intra-Level Nearest Neighbor Search

As illustrated in FIG. 8I, when the intra-prediction algorithm is turned on, in the same LOD level, a nearest neighbor search is performed on the set of encoded points in the same level to obtain the N neighbors of the current point (inter-level nearest neighbor search is also performed).

When performing attribute inter-level prediction, the nearest neighbor search is performed based on the fast search algorithm. The specific algorithm is illustrated in FIG. 8J. Assuming that the Morton code index of the current point is i, the nearest neighbor search will be performed in [i+1, i+searchRange]. The specific nearest neighbor search algorithm is consistent with the block-based inter fast search algorithm, which will not be repeated here and will be discussed in detail later.

The intra nearest neighbor search is described above. The inter nearest neighbor search is described below.

### Inter Nearest Neighbor Search

As illustrated in FIG. 8H, when performing attribute inter prediction, the Morton code corresponding to the current point are first obtained using the geometric coordinates of the current point to be encoded. Secondly, based on the Morton code of the current point, the reference point (j) whose Morton code is a first one greater than the Morton code of the current point is found in the reference picture. Then, the nearest neighbor search is performed in the range of [j−searchRange, j+searchRange].

At present, when performing intra nearest neighbor search and inter nearest neighbor search, the neighborhood search is performed based on blocks, as illustrated in FIG. 8K. When searching for the neighborhood of the current point (Morton code index is i), the points in the reference picture are first partitioned into N (N is equal to 3) levels according to the Morton code. The specific partition algorithm is as follows.

First level: it is assumed that the reference picture contains numPoints points, the points in the reference picture are first partitioned into a block every M (M=2⁵=32) points.

Second level: on the basis of the first level, the blocks of the first level are partitioned into one block every M (M=2⁵=32) blocks according to the order of Morton code.

Third level: on the basis of the second level, the blocks of the first level are partitioned into one block every M (M=2⁵=32) blocks according to the order of Morton code. Finally, the prediction structure illustrated in FIG. 8K is obtained.

When performing attribute prediction based on the prediction structure illustrated in FIG. 8K, assuming that the Morton code index of the current point to be encoded is i, the point in the reference picture whose Morton code is a first one greater than or equal to the Morton code of the current point is first obtained, with an index of j. Secondly, the block index of the reference point is calculated based on j. The specific calculation method is as follows.

$$First level : BucketSize\_ 0 = {2}^{5} = 32.$$

$$Second level : BucketSize\_ 1 = {2}^{5} = 32 \times BucketSize\_ 0 = 10 24.$$

$$Third level : BucketSize\_ 2 = {2}^{5} = 32 \times BucketSize\_ 1 = 32768 .$$

Assuming that the reference range in the prediction picture of the current point is [j−searchRange, j+searchRange], the starting index of the third level is calculated using j−searchRange, and the ending index of the third level is calculated using j+searchRange. Next, it is determined whether some blocks of the second level need to undergo nearest neighbor search in the blocks of the third level; then, moving to the second level, it is determined whether a search is needed for each block of the first level; if some blocks of the first level need to undergo nearest neighbor search, some points of the blocks of the first level will be determined point by point to update the nearest neighbors.

The index-based calculation block algorithm is introduced below. Assuming that the Morton code index corresponding to the current point is “index”, the index of the corresponding third level block is as shown in formula (17):

$$idx\_ 2 = index / BucketSize\_ 2 \qquad ( 17 )$$

After the index idx_2 of the third level block is obtained, the starting index and the ending index of the block of the second level corresponding to the current block may be obtained using idx_2, as shown in formula (18):

$$startIdx 1 = idx\_ 2 \times BucketSize\_ 1 \qquad ( 18 )$$

$$endIdx = idx\_ 2 \times BucketSize\_ 1 + BucketSize\_ 1 - 1$$

Based on the same algorithm, the index of the first level block is obtained based on the index of the second level block.

When performing nearest neighbor search based on blocks, it is first determined whether the current block needs to undergo nearest neighbor search, that is, filter the nearest neighbor search of the block. Each spatial block may be obtained based on two variables minPos and maxPos, where minPos represents the minimum value of the block and maxPos represents the maximum value of the block.

It is assumed that the distance of the farthest point among the N neighbors of the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as shown in formula (19):

$$int dx = int ( std \text{::} max ( std \text{::} max ( minPos [ 0 ] - point [ 0 ] , 0 ) , point [ 0 ] - maxPos [ 0 ] ) ) ; int dy = int ( s td \text{::} max ( std \text{::} max ( minPos [ 1 ] - point [ 1 ] , 0 ) , point [ 1 ] - maxPos [ 1 ] ) ) ; int dz = int ( std \text{::} max ( std \text{::} max ( minPos [ 2 ] - point [ 2 ] , 0 ) , point [ 2 ] - maxPos [ 2 ] ) ) ; D = dx + dy + dz \qquad ( 19 )$$

When D is less than or equal to Dist, the points in the current block will be traversed.

The lifting transform encoding of the attribute information of the point cloud is introduced below.

FIG. 8L illustrates an encoding process of the lifting transform. The lifting transform also performs predictive encoding on the attributes of the point cloud based on LOD. The difference from the prediction transform is that the lifting transform first partitions the LOD into higher and lower levels, performs prediction in the reversed order of the LOD level generation, and introduces an update operator in the prediction process to update the quantization weights of the points in the lower LOD level to improve the accuracy of the prediction. This is because the attribute values of points in the lower LOD level are frequently used to predict the attribute values of points in the higher LOD level, and points in the lower LOD level should have greater influence.

### Step 1: Partitioning Process

The partitioning process is to partition the complete LOD level into lower LOD levels L(N) and higher LOD levels H(N). If a point cloud has three levels of LOD, i.e., (LODl)_{l=0,1,2}, after partitioning, LOD₂ is the higher LOD level and denoted as H(N), and (LODₗ)_{l=0,1} are the lower LOD levels and denoted as L(N).

### Step 2: Prediction Process

The point in the higher LOD level selects the attribute information of the nearest neighbor points from the lower LOD level as the attribute prediction value P(N) of the current point to be encoded. The prediction residual D(N) is shown in formula (20):

$$D ( N ) = H ( N ) - P ( N ) \qquad ( 20 )$$

### Step 3: Update Process

The attribute prediction residual D(N) in the higher LOD level is updated to obtain U(N), and the attribute values of the points in the lower LOD level are lifted using U(N), as shown in (21):

$${L}^{′} ( N ) = L ( N ) + U ( N ) \qquad ( 21 )$$

The above process will iterate continuously until the lowest LOD level according to the order of LOD from high to low.

Since the LOD-based prediction scheme makes the points in the lower LODs have greater influence, the transform scheme based on lifting wavelet transform introduces quantization weights and updates the prediction residual according to the prediction residual D(N) and the distance between the prediction point and the neighboring points. Finally, adaptive quantization is performed on the prediction residual using the quantization weights in the transform process. It should be noted that the quantization weight value of each point may be determined by geometric reconstruction at the decoding side, so the quantization weight do not need to be encoded.

The region adaptive hierarchical transform is introduced below.

The region adaptive hierarchical transform (RAHT) is a Haar wavelet transform that may transform the attribute information of the point cloud from the spatial domain to the frequency domain and further reduce the correlation between the attributes of the point cloud. The main idea is to transform the nodes in each level from the three dimensions of x, y, and z (as illustrated in FIG. 8M) in a bottom-up manner according to the octree structure, and to perform iteration until reaching the root node of the octree. As illustrated in FIG. 8N, the basic idea is to perform wavelet transform based on the hierarchical structure of the octree, associate the attribute information with the nodes of the octree, and recursively transform the attributes of the occupied nodes in the same parent node in a bottom-up manner. The nodes in each level are transformed from the three dimensions of x, y, and z until reaching the root node of the octree. In the process of hierarchical transform, the low-pass (DC) coefficients obtained after transforming the nodes in the same level are passed to the nodes in the next level for further transformation, while all high-pass (AC) coefficients are encoded by the arithmetic encoder.

During the transformation process, the DC coefficient (direct current component) of the nodes in the same level after transformation will be passed to the previous level for further transformation, and the AC coefficient (alternating current component) after transformation of each level will be quantized and encoded. The main transformation process is introduced below.

FIG. 8O illustrates the corresponding transform and inverse transform process. Assuming that

$${g}_{L , 2 x , y , z}^{′} and {g}_{L , 2 x + 1 , y , z}^{′}$$

are two attributes DC coefficients that are neighboring points in the L level. After the linear transformation, the information of the L-1 level is the AC coefficient

$${f}_{L - 1 , x , y , z}^{′}$$

and the DC coefficient

$${g}_{L - 1 , x , y , z}^{′} ;$$

then, no more transform will be performed on

$${f}_{L - 1 , x , y , z}^{′} ,$$

and quantization encoding will be performed on

$${f}_{L - 1 , x , y , z}^{′}$$

directly;

$${g}_{L - 1 , x , y , z}^{′}$$

will continue to search nearest neighbors for transformation, and it will be passed directly to the L-2 level if none are found. That is, the RAHT transform is only valid for nodes with neighboring points, and nodes without neighboring points will be passed directly to the previous level. In the above transformation process, the weights corresponding to

$${g}_{L , 2 x , y , z}^{′} and {g}_{L , 2 x + 2 , y , z}^{′}$$

(the number of non-empty child nodes in a node) are

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′}$$

is

$${w}_{L - 1 , x , y , z}^{′} ,$$

then the general transformation formula (22) is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 22 )$$

For example, T_{w0,w1} in the formula is a transformation matrix determined according to the following formula (23):

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 23 )$$

The transform matrix will be updated as the weights corresponding to each point change adaptively. The above process will be continuously iterated and updated based on the partition structure of the octree until reaching the root node of the octree.

The encoding and decoding technology of the geometry information of the point cloud and the encoding and decoding technology of the attribute information of the point cloud are described above.

In the process of point cloud attribute encoding, at least one neighboring point of the current point is determined through an inter search, and the attribute prediction value of the current point is predicted based on the attribute information of the at least one neighboring point. However, at present, the inter nearest neighbor search for attributes is block-based inter fast search, which fails to utilize the spatial correlation of the point cloud. The determination of the inter neighboring point(s) is inaccurate, resulting in poor attribute prediction performance.

In order to solve the above technical problems, according to the embodiments of the present disclosure, when performing the inter nearest neighbor search for attributes, M neighborhood blocks corresponding to a current point in a reference picture of the current point are first determined; and an attribute prediction value of the current point is determined based on attribute information of points included in these M neighborhood blocks. That is, in the embodiments of the present disclosure, when determining neighboring points of the current point, a spatial correlation between attributes of the point cloud is taken into consideration, so as to improve the accuracy of determining the neighboring points. When performing prediction on attribute information of the current point based on attribute information of accurately determined neighboring points, the accuracy of attribute prediction may be enhanced, thereby improving the encoding and decoding effect of the attribute information of the point cloud.

The point cloud encoding/decoding method involved in the embodiments of the present disclosure is introduced below in conjunction with the specific embodiments.

First, the point cloud decoding method provided in the embodiments of the present disclosure is introduced by taking the decoding side as an example.

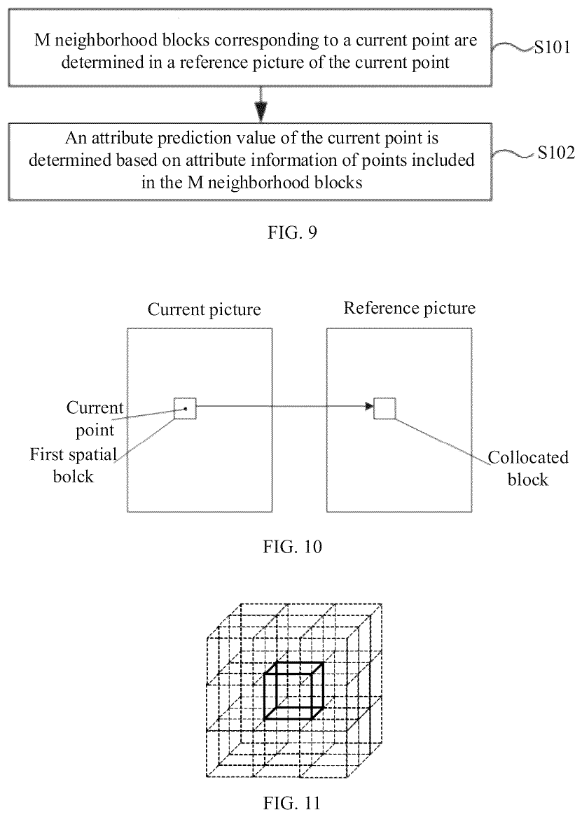

FIG. 9 is a flowchart of a point cloud decoding method according to the embodiments of the present disclosure. The point cloud decoding method of the embodiments of the present disclosure may be completed by a point cloud decoding device or a point cloud decoder illustrated in FIG. 3 or FIG. 4B.

As illustrated in FIG. 9, the point cloud decoding method in the embodiments of the present disclosure includes the following.

In S101, M neighborhood blocks corresponding to a current point are determined in a reference picture of the current point.

The current point is a point in a point cloud whose attribute information is to be decoded, and M being a positive integer.

As can be seen from the above, the point cloud includes geometry information and attribute information, and decoding the point cloud includes geometric decoding and attribute decoding. The embodiments of the present disclosure relate to the attribute decoding of the point cloud.

In the embodiments of the present disclosure, the point cloud attribute decoding is performed after the point cloud geometric decoding. That is, in the embodiments of the present disclosure, first, the geometry information of the point cloud is decoded to obtain a point cloud after the geometry information is decoded. Next, based on the point cloud after the geometry information is decoded, the attribute information decoding is performed on the point cloud.

In some embodiments, when the attribute information of the point cloud is decoded, the point cloud is partitioned into multiple levels based on the geometry information of the point cloud, so as to decode attribute information of each point in each level in a level-by-level manner.

For example, the point cloud may be partitioned into multiple level-of-details (LOD) levels based on the geometry information of the point cloud, and attribute information of each point in each LOD level is decoded.

In some embodiments, the point cloud is first sorted before the point cloud is partitioned into multiple levels. For example, based on geometry information of each point in the point cloud, the Morton code of each point in the point cloud is determined, and then the points in the point cloud are sorted based on the Morton codes to obtain a Morton-sorted point cloud.

In the embodiments of the present disclosure, the decoding process of the attribute information of each point in each level is basically the same. Taking a certain point in a certain level of the point cloud as an example, first, it is determined that N neighboring point(s) whose attribute information has been decoded of the current point are searched, where N is a positive integer. Next, the attribute information of the current point is predicted based on attribute information (i.e., attribute reconstructed values) of the N neighboring point(s). For example, the attribute information of one neighboring point among the N neighboring point(s) is determined as the attribute prediction value of the current point, or a weighted average of the attribute information of the N neighboring point(s) is determined as the attribute prediction value of the current point.

When determining the N neighboring point(s) of the current point, the intra nearest neighbor search and/or the inter nearest neighbor search are generally involved.

For example, in some embodiments, only the intra nearest neighbor search mode is adopted to determine the N neighboring point(s) of the current point. In some embodiments, only the inter nearest neighbor search mode is adopted to determine the N neighboring point(s) of the current point.

For another example, in some embodiments, both the intra nearest neighbor search mode and the inter nearest neighbor search mode are adopted to determine the N neighboring points of the current point.

At present, when performing the inter nearest neighbor search, the block-based inter fast search is adopted. For example, a point is determined in the reference picture based on an index of the current point, and at least one neighboring point of the current point is searched among points near the point in the reference picture. In order to improve searching speed of the neighboring points, relevant points in the reference picture are partitioned into multiple blocks, and an intra nearest neighbor is searched through a block-based mode. However, attribute values of points on a local area of a surface in the point cloud have a high correlation, while the current inter nearest neighbor search mode fails to utilize the spatial correlation of the point cloud, so that the determination of the inter (or referred to as inter-frame) neighboring points is inaccurate, resulting in poor attribute prediction performance.

In order to solve the above technical problem, in the embodiments of the present disclosure, when performing inter nearest neighbor search for attributes, the M neighborhood blocks corresponding to the current point is first determined in the reference picture of the current point; and the attribute prediction value of the current point is determined based on the attribute information of the points included in the M neighborhood blocks. That is, in the embodiments of the present disclosure, when determining the neighboring points of the current point, the spatial correlation of the points in the point cloud is taken into consideration, so as to improve the accuracy of determining the neighboring points. The attribute prediction value of the current point is determined based on the attribute information of the accurately determined neighboring points, and the prediction accuracy of the attribute prediction value may be enhanced, thereby improving the attribute prediction effect of the point cloud.

The specific process in which the decoding side determines the M neighborhood blocks corresponding to the current point in the reference picture of the current point is introduced below.

In some embodiments, when decoding the attribute information of the point cloud, the decoding side may not perform level partitioning on the point cloud. As such, the current point may be understood as any point in the point cloud whose attribute information is to be decoded.

In some embodiments, when decoding the corresponding attribute information, the decoding side performs level partitioning on the point cloud, such as performing an LOD level partitioning on the point cloud. As such, the current point may be understood as any point in the LOD level of the point cloud whose attribute information is to be decoded.

When the attribute information of the current point is decoded, the reference picture of the current point is first determined. The geometric information and the attribute information of the reference picture have been decoded.

In the embodiments of the present disclosure, the reference picture (or referred to as reference frame) of the current point may be understood as a reference picture of a current picture (or referred to as current frame) where the current point is located.

The number of reference pictures of the current point is not limited in the embodiments of the present disclosure. That is, the current point has one or more reference pictures.

In some embodiments, the reference picture of the current point includes a forward reference picture of the current picture.

In some embodiments, the reference picture of the current point includes a backward reference picture of the current picture.

In some embodiments, the reference picture of the current point includes a forward reference picture of the current picture and a backward reference picture of the current picture.

Next, the decoding side determines the M neighborhood blocks corresponding to the current point in the reference picture of the current point.

In some embodiments, before determining the M neighborhood blocks corresponding to the current point in the reference picture of the current point, the decoding side first performs block partitioning on the point cloud, so as to determine the M neighborhood blocks corresponding to the current point among blocks included in the reference picture.

In a possible implementation, before decoding the attribute information of the point cloud, the decoding side performs block partitioning on the point cloud based on the decoded geometry information of the point cloud, to partition the point cloud into multiple sub-blocks. During the subsequent decoding of the attribute information of the point cloud, inter neighborhood blocks of the current point are searched based on the partitioned point cloud sub-blocks.

In a possible implementation, when decoding the attribute information of each picture of point cloud (or referred to as each frame of point cloud), the decoding side performs block partitioning on the point cloud once. When performing attribute decoding on the point in each picture of the point cloud, the inter neighborhood blocks of the point in the picture are searched among the sub-blocks of the point cloud obtained from partitioning the picture. For example, when performing attribute decoding on the first picture of the point cloud, the decoding side performs block partitioning on the point cloud. When decoding any point in the first picture of the point cloud, the decoding side searches for the inter neighborhood blocks of the point among the point cloud sub-blocks obtained from the first partitioning. When performing attribute decoding on the second picture of the point cloud, the decoding side re-performs block partitioning on the point cloud. When decoding any point in the second picture of the point cloud, the decoding side searches for the inter neighborhood blocks of the point among the point cloud sub-blocks obtained from the second partitioning, and so on. It is to be noted that the block partitioning manner for the point cloud may be the same or different each time, which is not limited in the embodiments of the present disclosure.

In a possible implementation, when decoding the attribute information of each point in the point cloud, the decoding side performs block partitioning on the point cloud once. For example, when performing attribute decoding on point 1 in the point cloud, the decoding side performs block partitioning on the point cloud, and then searches for the inter neighborhood blocks of the point 1 among the point cloud sub-blocks obtained from the first partitioning. When performing attribute decoding on point 2 in the point cloud, the decoding side re-performs block partitioning on the point cloud, and then searches for the inter neighborhood blocks of the point 2 among the point cloud sub-blocks obtained from the second partitioning, and so on. It is to be noted that the block partitioning manner for the point cloud may be the same or different each time, which is not limited in the embodiments of the present disclosure.

The specific manner of performing block partitioning on the point cloud is not limited in the embodiments of the present disclosure. For example, the specific manner may be binary tree partitioning, quadtree partitioning, hextree partitioning, octree partitioning, and so on.

The specific manner in which the decoding side determines the M neighborhood blocks corresponding to the current point in the reference picture of the current point is not limited in the embodiments of the present disclosure.

In some embodiments, a point whose index is closest to the index of the current point is determined in the reference picture based on the index of the current point, and a block where the point is located is determined (i.e., a spatial block of the point) in the reference picture. M neighborhood blocks of the spatial block are searched in the reference picture. For example, M neighborhood blocks of the spatial block sharing a face, an edge or a vertex with the spatial block are searched in the reference picture, and the M neighborhood blocks of the spatial block are determined as the M neighborhood blocks of the current point. For example, the point 1 whose index is closest to the index of the current point is determined in the reference picture based on the index of the current point, and a spatial block 1 of the point 1 is determined in the reference picture. Next, M neighborhood blocks sharing a face, an edge or a vertex with the spatial block 1 are searched among blocks included in the reference picture, so as to determine these M neighborhood blocks as the M neighborhood blocks of the current point.

In some embodiments, the decoding side determines the M neighborhood blocks corresponding to the current point in the reference picture of the current point through following steps.

In S101-A, a first spatial block of the current point is determined in the current picture.

In S101-B, a collocated block of the first spatial block is determined in a reference picture.

In S101-C, M neighborhood blocks of the collocated block are determined in the reference picture, and the M neighborhood blocks of the collocated block are taken as the M neighborhood blocks corresponding to the current point.

In the embodiments, as illustrated in FIG. 10, when the M neighborhood blocks corresponding to the current point are determined in the reference picture, the spatial block where the current point is located is first determined in the current picture, and the spatial block is recorded as the first spatial block. Next, the collocated block of the first spatial block is determined in the reference picture, and then, the M neighborhood blocks of the collocated block are determined in the reference picture. For example, as illustrated in FIG. 11, assuming that a block with dark wireframe is the collocated block, the collocated block has 6 co-planar blocks, 12 co-edge blocks and 8 co-vertex blocks. The M neighborhood blocks of the collocated block are determined from these 6 co-planar blocks, 12 co-edge blocks and 8 co-vertex blocks. The M neighborhood blocks of the collocated block are determined as the M neighborhood blocks corresponding to the current point.

In the S101-B, the specific implementation of determining the collocated block of the first spatial block in the reference picture includes, but is not limited to, the following.

Manner I: the S101-B includes step S101-B-a as follows.

In S101-B-a, the collocated block of the first spatial block is determined in the reference picture based on position information of the first spatial block.

In the manner I, the decoding side may directly determine the collocated block in the reference picture based on the position information of the first spatial block. In this way, the collocated block of the first spatial block may be determined quickly, so as to improve the attribute decoding efficiency.

The specific manner in which the decoding side determines the collocated block of the first spatial block in the reference picture based on the position information of the first spatial block is not limited in the embodiments of the present disclosure.

In an example, the decoding side determines, based on the position information of the first spatial block, a block in the reference picture whose position information is consistent with the position information of the first spatial block as the collocated block of the first spatial block. Assuming that position coordinates of the first spatial block in the current picture arc (x0, y0, z0), the block with the position coordinates (x0, y0, z0) is searched in the reference picture, and the block is determined as the collocated block of the first spatial block in the reference picture.

The specific expression form of the position information of the first spatial block is not limited in the embodiments of the present disclosure. For example, as illustrated in FIG. 12, the position coordinates (x0, y0, z0) of the first spatial block in the current picture may be coordinate values of the lower left corner (or other positions) of the first spatial block. Therefore, the block whose lower left corner position coordinates (x0, y0, z0) in the reference picture is determined as the collocated block of the first spatial block in the reference picture.

In another example, the decoding side determines, based on the position information of the first spatial block, a block in the reference picture whose distance from the first spatial block meets a preset requirement as the collocated block of the first spatial block.

The preset requirement is not limited in the embodiments of the present disclosure. For example, the preset requirement is that the distance is minimum. That is, the decoding side determines, based on the position information of the first spatial block, the distance between each block in the reference picture and the first spatial block, selects a block with the minimum distance and determines the block as the collocated block of the first spatial block in the reference picture. For another example, the preset requirement is that the distance is less than or equal to a preset value. In this way, the decoding side determines, based on the position information of the first spatial block, the distance between each block in the reference picture and the first spatial block, selects a block whose distance is less than or equal to the preset value, and determines the block as the collocated block of the first spatial block in the reference picture.

For example, the decoding side may determine the distance between the block in the reference picture and the first spatial block based on the following formula (24):

$$D = \vert x 0 - xi \vert + \vert y 0 - yi \vert + \vert z 0 - zi \vert \qquad ( 24 )$$

Where (x0, y0, z0) is the position information of the first spatial block in the current picture, (xi, yi, zi) is the position information of i-th block in the reference picture, ∥ represents an absolute value operation, and D is a distance between the first spatial block and the i-th block in the reference picture.

The size of the collocated block is not limited in the embodiments of the present disclosure.

In some embodiments, when the decoding side performs block partitioning on the point cloud and the sizes of the partitioned point cloud sub-blocks are all consistent, the size of the collocated block of the first spatial block determined by the decoding side is consistent with the size of the first spatial block.

In some embodiments, when the decoding side performs block partitioning on the point cloud and the sizes of the partitioned point cloud sub-blocks are not completely consistent, the S101-B-a includes step S101-B-al as follows.

In S101-B-al, the decoding side determines the collocated block of the first spatial block in the reference picture based on the position information of the first spatial block and the size of the first spatial block.

For example, a block in the reference picture whose position information is consistent with the position information of the first spatial block and whose size is consistent with the size of the first spatial block is determined as the collocated block of the first spatial block.

In some embodiments, when there is no block in the reference picture whose position information is consistent with the position information of the first spatial block and whose size is consistent with the size of the first spatial block, the decoding side searches for a block in the reference picture whose position information is closest to the position information of the first spatial block and whose size is closest to the size of the first spatial block based on the position information and the size of the first spatial block, and determines the block as the collocated block of the first spatial block in the reference picture.

In addition to determining the collocated block of the first spatial block in the reference picture using the manner I, the decoding side may also determine the collocated block of the first spatial block using the manner II as follows.

Manner II: the S101-B includes steps S101-B-b1 to S101-B-b3 as follows.

In S101-B-b1, a first reference point corresponding to the current point is determined in the reference picture.

In S101-B-b2, a second spatial block of the first reference point is determined in the reference picture.

In S101-B-b3, the second spatial block is determined as the collocated block of the first spatial block.

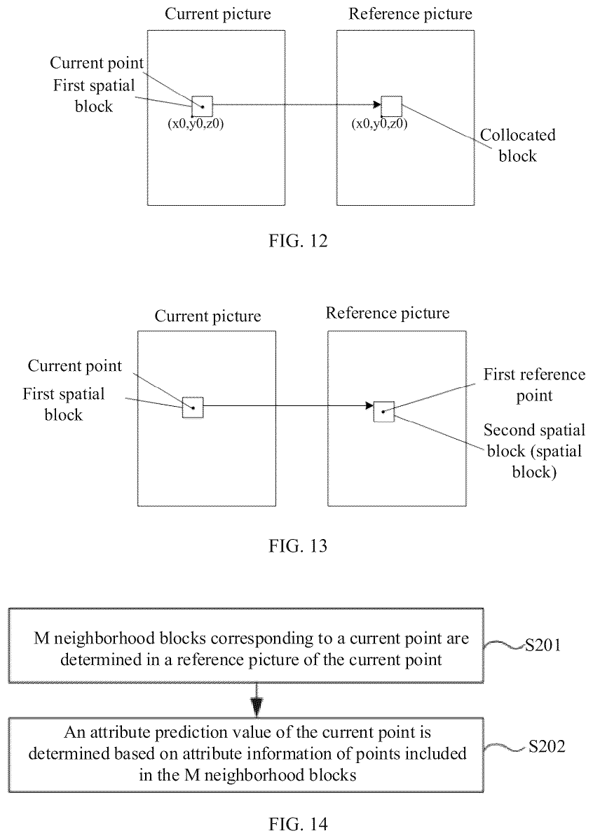

In the manner II, as illustrated in FIG. 13, when determining the collocated block of the first spatial block in the reference picture, the decoding side first determines the first reference point corresponding to the current point in the reference picture; then, determines the second spatial block of the first reference point in the reference picture; and finally, determines the second spatial block as the collocated block of the first spatial block in the reference picture.

The specific manner in which the decoding side determines the first reference point corresponding to the current point in the reference picture is not limited in the embodiments of the present disclosure.

In a possible implementation, the decoding side determines the first reference point in the reference picture based on the position information of the current point in the current picture. For example, the decoding side determines a point in the reference picture whose position information is consistent with the position information of the current point in the current picture as the first reference point of the current point in the reference picture. For another example, when there is no point in the reference picture whose position information is consistent with the position information of the current point in the current picture, the distance between the position information of each point in the reference picture and the position information of the current point in the current picture is determined, and the point in the reference picture with the minimum distance is determined as the first reference point of the current point in the reference picture.

In a possible implementation, the first reference point is determined in the reference picture based on an index of the current point.

When performing attribute decoding on the point cloud, the decoding side determines the index of each point in the point cloud, for example, determining a Morton code of each point in the point cloud, and records the Morton code as the index of the point. Next, the point cloud is sorted based on the index of each point in the point cloud, and LOD partitioning is performed on the sorted point cloud. It may be seen that each point in the point cloud has an index, and thus, the decoding side may determine the first reference point corresponding to the current point in the reference picture according to the index of the current point.

For example, a point in the reference picture whose index is the same as the index of the current point is determined as the first reference point corresponding to the current point in the reference picture.

For another example, a point among points included in the reference picture whose index is a first one greater than or equal to the index of the current point is determined as the first reference point corresponding to the current point in the reference picture.

Optionally, the index is the Morton code index. That is, the decoding side determines the point in the reference picture whose Morton code index is the same as the Morton code index of the current point as the first reference point corresponding to the current point in the reference picture. Alternatively, the decoding side determines the point among the points included in the reference picture whose Morton code index is a first one greater than or equal to the Morton code index of the current point as the first reference point corresponding to the current point in the reference picture.

After determining the first reference point corresponding to the current point in the reference picture based on the above steps, the decoding side determines the second spatial block of the first reference point in the reference picture.

In the manner II, there is no limitation on the size of the second spatial block.

In some embodiments, when the decoding side performs block partitioning on the point cloud and the sizes of the partitioned point cloud sub-blocks are all consistent, the size of the second spatial block determined by the decoding side is consistent with the size of the first spatial block.

In some embodiments, when the decoding side performs block partitioning on the point cloud and the sizes of the partitioned point cloud sub-blocks are not completely consistent, the S101-B-b2 includes step S101-B-b21 as follows.

In S101-B-b21, the decoding side determines the second spatial block of the first reference point in the reference picture based on the size of the first spatial block.

For example, when the size of the spatial block where the first reference point is located is consistent with the size of the first spatial block, the spatial block where the first reference point is located is directly determined as the second spatial block of the first reference point. As such, the size of the second spatial block is consistent with the size of the first spatial block.

For another example, when the size of the spatial block where the first reference point is located is inconsistent with the size of the first spatial block, the spatial block where the first reference point is located may be determined as the second spatial block of the first reference point. As such, the size of the second spatial block is inconsistent with the size of the first spatial block. For another example, when the size of the spatial block where the first reference point is located is inconsistent with the size of the first spatial block, a block among the blocks near the first reference point whose size is consistent with or closest to the size of the first spatial block is searched and determined as the second spatial block of the first reference point based on the first reference point. As such, the size of the second spatial block is substantially consistent with the size of the first spatial block.

In the manner II, after determining the second spatial block of the first reference point in the reference picture based on the above steps, the decoding side determines the second spatial block as the collocated block of the first spatial block in the reference picture.

After determining the collocated block of the first spatial block in the reference picture based on the above method, the decoding side performs step S101-C to determine the M neighborhood blocks of the collocated block in the reference picture, and takes the M neighborhood blocks of the collocated block as the M neighborhood blocks corresponding to the current point.

For example, the decoding side determines M co-planar neighborhood blocks of the collocated block (i.e., M neighborhood blocks sharing a face with the collocated block) in the reference picture, and determines the M co-planar neighborhood blocks as the M neighborhood blocks corresponding to the current point.

For another example, the decoding side determines M co-edge neighborhood blocks of the collocated block (i.e., M neighborhood blocks sharing an edge with the collocated block) in the reference picture, and determines the M co-edge neighborhood blocks as the M neighborhood blocks corresponding to the current point.

For another example, the decoding side determines M co-vertex neighborhood blocks of the collocated block (i.e., M neighborhood blocks sharing a vertex with the collocated block) in the reference picture, and determines the M co-vertex neighborhood blocks as the M neighborhood blocks corresponding to the current point.

For another example, the decoding side determines M co-planar and co-edge neighborhood blocks of the collocated block (i.e., M neighborhood blocks sharing a face or edge with the collocated block) in the reference picture, and determines the M co-planar and co-edge neighborhood blocks as the M neighborhood blocks corresponding to the current point.

For another example, the decoding side determines M co-planar and co-vertex neighborhood blocks of the collocated block (i.e., M neighborhood blocks sharing a face or vertex with the collocated block) in the reference picture, and determines the M co-planar and co-vertex neighborhood blocks as the M neighborhood blocks corresponding to the current point.

For another example, the decoding side determines M co-edge and co-vertex neighborhood blocks of the collocated block (i.e., M neighborhood blocks sharing an edge or vertex with the collocated block) in the reference picture, and determines the M co-edge and co-vertex neighborhood blocks as the M neighborhood blocks corresponding to the current point.

For another example, the decoding side determines M co-planar, co-edge and co-vertex neighborhood blocks of the collocated block (i.e., M neighborhood blocks sharing a face, edge or vertex with the collocated block) in the reference picture, and determines the M co-planar, co-edge and co-vertex neighborhood blocks as the M neighborhood blocks corresponding to the current point.

After determining the M neighborhood blocks corresponding to the current point based on the above steps, the decoding side performs the following step S102.

In S102, an attribute prediction value of the current point is determined based on attribute information of points included in the M neighborhood blocks.

In the embodiments of the present disclosure, based on the above steps, the decoding side determines the M neighborhood blocks corresponding to the current point in the reference picture, and then performs prediction on the attribute information of the current point based on the attribute information (i.e., attribute reconstruction values) of the points included in the M inter neighborhood blocks. The points included in the M inter neighborhood blocks have correlation with the current point spatially, and then, when prediction is performed on the attribute information of the current point based on the attribute information of the points included in the M inter neighborhood blocks, the prediction accuracy may be enhanced, thereby improving the accuracy of attribute prediction of the point cloud and improving the attribute decoding effect of the point cloud.

The specific manner in which the decoding side determines the attribute prediction value of the current point based on the attribute information of the points included in the M neighborhood blocks is not limited in the embodiments of the present disclosure.

In some embodiments, the decoding side may determine the attribute prediction value of the current point based on the attribute information of all points included in the M neighborhood blocks. Assuming that the M neighborhood blocks include K points in total, the attribute prediction value of the current point is determined based on the attribute information of the K points.

For example, the average value of the attribute information of the K points is determined as the attribute prediction value of the current point.

For another example, the weighted average value of the attribute information of the K points is determined as the attribute prediction value of the current point. For example, the weight corresponding to each of the K points is the inverse of the distance from the point to the current point.

In some embodiments, the S102 includes following steps.

In S102-A1, at least one first neighboring point is determined among the points included in the M neighborhood blocks.

In S102-A2, the attribute prediction value of the current point is determined based on attribute information of the at least one first neighboring point.

In the implementation, based on the above steps, the decoding side determines the M neighborhood blocks corresponding to the current point in the reference picture; selects at least one neighboring point from the points included in the M neighborhood blocks and records the at least neighboring point as the first neighboring point; and finally, predicts the attribute information of the current point based on the attribute information of the selected at least one first neighboring point.

For example, it is assumed that the M neighborhood blocks include K points in total, K being a positive integer, and it is assumed that the upper-layer syntax specifies that the number of nearest neighbor points through inter searched is N. It is assumed that K is greater than N, the decoding side selects N points from the K points included in the M neighborhood blocks as the first neighboring points of the current point, and determines the attribute prediction value of the current point based on the attribute information of the N first neighboring points.

In an example, if K=1, the decoding side determines a point that is uniquely included in the M neighborhood blocks as the first neighboring point of the current point.

In an example, if K is greater than 1 and greater than N, the decoding side selects N points from the K points as N first neighboring points of the current point.

The specific manner in which the decoding side selects the N points from the K points is not limited in the embodiments of the present disclosure.

For example, since the geometry information of the point cloud has been decoded, the geometry information of each point in the point cloud is known. Therefore, in the embodiments of the present disclosure, the decoding side may determine, based on the geometry information of each of the K points included in the M neighborhood blocks and the geometry information of the current point, the distance between each of the K points and the current point; and select N points from the K points based on the distance. For example, N points closest to the current point are selected from these K points as the N first neighboring points of the current point.

After determining the at least one first neighboring point of the current point among the points included in the M inter neighborhood blocks corresponding to the current point based on the above steps, the decoding side determines the attribute prediction value of the current point based on the attribute information of the at least one first neighboring point.

For example, in a case where the at least one first neighboring point includes one first neighboring point, the attribute information of the first neighboring point is determined as the attribute prediction value of the current point.

For another example, in a case where the at least one first neighboring point includes multiple first neighboring points, the average value of the attribute information of the multiple first neighboring points is determined as the attribute prediction value of the current point.

For another example, in a case where the at least one first neighboring point includes multiple first neighboring points, the weighted average value of the attribute information of the multiple first neighboring points is determined as the attribute prediction value of the current point.

For example, the decoding side determines the attribute prediction value of the current point based on the following formula (25):

$${\hat{a}}_{i} = Round ( {\sum }_{j = 0}^{N - 1} \frac{{\tilde{w}}_{ij}}{{\sum }_{j = 0}^{N - 1} {\tilde{w}}_{ij}} {\tilde{a}}_{j} ) \qquad ( 25 )$$

Where âᵢ represents the attribute prediction value of the current point i, j represents indexes of the N neighboring points (e.g., the first neighboring point), ãⱼ represents the attribute information (i.e., the attribute reconstructed value) of the j-th neighboring point, and represents a spatial geometric weight from the j-th neighboring point to the current point.

For example, the spatial geometric weight from the j-th neighboring point to the current point may be determined by the following formula (26):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 26 )$$

Where (xᵢ, yᵢ, zᵢ) is the geometric coordinates of the current point, and (xᵢⱼ, yᵢⱼ, zᵢⱼ) is the geometric coordinates of the j-th neighboring point.

The processes in which the decoding side determines the M inter neighborhood blocks of the current point in the reference picture and performs prediction on the attribute information of the current point based on the attribute information of the points included in the M inter neighborhood blocks are introduced in the above embodiments.

In some embodiments, when the number of the first neighboring points determined by the decoding side among the points included in the M neighborhood blocks does not meet a first preset number, the method in the embodiments of the present disclosure further include steps 11 and 12 as follows.

In step 11: a first determination mode is adopted to determine Q second neighboring points of the current point, Q being an integer.

In step 22: the attribute prediction value of the current point is determined based on attribute information of the Q second neighboring points.

The first determination mode is not limited in the embodiments of the present disclosure.

For example, the first determination mode is an intra nearest neighbor search mode and/or a block-based inter nearest neighbor search mode.

In the present embodiments, it is assumed that the number of the first neighboring points required to be determined by the decoding side is the first preset number R, the number of the points included in the M neighborhood blocks is K, and the number of the first neighboring points determined among the K points included in the M neighborhood blocks is N. If N is less than R, the decoding side adopts the first determination mode to determine the Q second neighboring points of the current point.

For example, the decoding side adopts the intra nearest neighbor search mode to search for the Q second neighboring points of the current point in the current picture.

For another example, the decoding side adopts the block-based inter nearest neighbor search mode to search for the Q second neighboring points of the current point in the reference picture.

For another example, the decoding side adopts the intra nearest neighbor search mode to search for at least one second neighboring point of the current point in the current picture, and adopts the block-based inter nearest neighbor search mode to search for at least one second neighboring point of the current point in the reference picture, so as to search for the Q second neighboring points of the current point in intra-picture and inter-picture (i.e., in intra-frame and inter-frame).

Next, the decoding side determines the attribute prediction value of the current point based on the attribute information (i.e., the attribute reconstruction values) of the Q second neighboring points.

In an example, the decoding side determines the attribute prediction value of the current point based on the attribute information of the Q second neighboring points only, without considering the first neighboring point(s).

For example, the average value of the attribute information of the Q second neighboring points is determined as the attribute prediction value of the current point. For another example, the weighted average value of the attribute information of the Q second neighboring points is determined as the attribute prediction value of the current point. Exemplarily, the weighted average formula may refer to the above formula (25).

In another example, the attribute prediction value of the current point is determined based on the attribute information of the Q second neighboring points and the attribute information of the points included in the M neighborhood blocks.

For example, the average value of the attribute information of the Q second neighboring points and the first neighboring point(s) determined above is determined as the attribute prediction value of the current point. For another example, the weighted average of the attribute information of the Q second neighboring points and the first neighboring point(s) determined above is determined as the attribute prediction value of the current point. For example, the weighted average formula may refer to the above formula (25).

In some embodiments, if the point cloud is a sparse point cloud, there may be no neighborhood block corresponding to the current point in the reference picture. As such, the method in the embodiments of the present disclosure further includes steps 21 and 22 as follows.

In step 21: in response to no neighborhood block corresponding to the current point existing in the reference picture, the decoding side adopts the first determination mode to determine P second neighboring points of the current point, P being an integer.

In step 22: the attribute prediction value of the current point is determined based on attribute information of the P second neighboring points.

In the embodiments of the present disclosure, if the decoding side fails to determine the neighborhood block corresponding to the current point in the reference picture based on the above steps, the decoding side adopts the first determination mode to determine the P second neighboring points of the current point.

For example, the decoding side adopts the intra nearest neighbor search mode to search for the P second neighboring points of the current point in the current picture.

For another example, the decoding side adopts the block-based inter nearest neighbor search mode to search for the P second neighboring points of the current point in the reference picture.

For another example, the decoding side adopts the intra nearest neighbor search mode to search for at least one second neighboring point of the current point in the current picture, and adopts the block-based inter nearest neighbor search mode to search for at least one second neighboring point of the current point in the reference picture, so as to search for the P second neighboring points of the current point in intra-picture and inter-picture (i.e., in intra-frame and inter-frame).

Next, the decoding side determines the attribute prediction value of the current point based on the attribute information (i.e., the attribute reconstruction values) of the P second neighboring points. For example, the average value of the attribute information of the P second neighboring points is determined as the attribute prediction value of the current point. For another example, the weighted average value of the attribute information of the P second neighboring points is determined as the attribute prediction value of the current point. For example, the weighted average formula may refer to the above formula (25).

In some embodiments, when the number of the second neighboring points of the current point determined by the decoding side based on the above steps does not meet a second preset number, the method in the embodiments of the present disclosure further includes the following.

In step 31: a second reference point corresponding to the current point is determined in the reference picture.

In step 32: at least one third neighboring point of the current point is determined in the reference picture based on the second reference point and a preset search range.

In step 33: the attribute prediction value of the current point is determined based on attribute information of the at least one third neighboring point.

The specific manner in which the decoding side determines the second reference point corresponding to the current point in the reference picture is not limited in the embodiments of the present disclosure.

For example, the decoding side determines a point in the reference picture whose position information is consistent with the position information of the current point in the current picture as the second reference point.

For another example, the decoding side determines a point among the points included in the reference picture whose index is a first one greater than or equal to the index of the current point as the second reference point.

Optionally, the above index is the Morton code index.

After determining the second reference point j corresponding to the current point in the reference picture, the decoding side determines the at least one third neighboring point of the current point in the reference picture based on the second reference point j and the preset search range searchRange.

For example, the decoding side determines the at least one third neighboring point of the current point within the range of [j−searchRange, j] of the reference picture.

For another example, the decoding side determines the at least one third neighboring point of the current point within the range of [j, j+searchRange] of the reference picture.

For another example, the decoding side determines the at least one third neighboring point of the current point within the range of [j−searchRange, j+searchRange] of the reference picture.

The decoding side determines the at least one third neighboring point of the current point in the reference picture, and then, determines the attribute prediction value of the current point based on the at least one third neighboring point.

In an example, the decoding side determines the attribute prediction value of the current point based on the at least one third neighboring point determined above only. For example, the average value or weighted average value of the attribute information of the at least one third neighboring point is determined as the attribute prediction value of the current point.

In an example, the decoding side determines the attribute prediction value of the current point based on the at least one second neighboring point and the at least one third neighboring point determined above. For example, the average value or weighted average value of the attribute information of the at least one second neighboring point and the at least one third neighboring point is determined as the attribute prediction value of the current point.

In an example, the decoding side determines the attribute prediction value of the current point based on the at least one first neighboring point, the at least one second neighboring point and the at least one third neighboring point determined above. For example, the average value or weighted average value of the attribute information of the at least one first neighboring point, the at least one second neighboring point and the at least one third neighboring point is determined as the attribute prediction value of the current point.

As can be seen from the above, the method proposed in the embodiments of the present disclosure in which the neighboring points are determined in inter-picture (i.e., inter-frame) based on the geometry information (i.e., the M neighborhood blocks corresponding to the current point are determined in inter-picture, and the at least one first neighboring point of the current point is determined based on the points included in the M neighborhood blocks) may be combined with the existing method in which the neighboring points are determined, so as to improve the accuracy of determining the neighboring points, thereby improving the attribute prediction effect of the point cloud.

In order to further describe the decoding effect of the point cloud decoding method proposed in the embodiments of the present disclosure, the point cloud decoding method proposed in the embodiments of the present disclosure is tested below. The test results are shown in Table 1 and Table 2.

TABLE 1
Lossless Geometry, Lossless Attributes [full intra]

| Test sequence | Reflectance |
|---|---|
| AM-frame Rotation Average | −8.1% |
| AM-frame no rotation average | 0.0% |

As shown in Table 1, under the decoding conditions of lossless geometry and lossless attributes, the point cloud decoding method provided in the embodiments of the present disclosure can bring 8.1% gain when the reflectance attribute is decoded.

TABLE 2
Lossy Geometry, Lossy Attributes [full intra]

| Test sequence | Reflectance |
|---|---|
| AM-Frame Rotation Average | −10.1% |

As shown in Table 2, under the decoding conditions of lossy geometry and lossy attributes, the point cloud decoding method provided in the embodiments of the present disclosure can bring 10.1% gain when the reflectance attribute is decoded.

According to the point cloud decoding method provided in the embodiments of the present disclosure, when performing intra nearest neighbor search for attributes, the M neighborhood blocks corresponding to the current point are first determined in the reference picture of the current point; and the attribute prediction value of the current point is determined based on the attribute information of the points included in the M neighborhood blocks. That is, in the embodiments of the present disclosure, when determining the neighboring points of the current point, the spatial correlation between the point cloud attributes is taken into consideration, so as to improve the accuracy of determining the neighboring points. When performing prediction on the attribute information of the current point based on the attribute information of the accurately determined neighboring points, the accuracy of attribute prediction may be enhanced, thereby improving the decoding effect of the attribute information of the point cloud.

The point cloud decoding method provided in the embodiments of the present disclosure is introduced in detail above by taking the decoding side as an example, and the point cloud encoding method provided in the embodiments of the present disclosure is introduced below by taking the encoding side as an example.

FIG. 14 is a flowchart of a point cloud encoding method according to the embodiments of the present disclosure. The point cloud encoding method of the embodiments of the present disclosure may be completed by a point cloud encoding device illustrated in FIG. 3 or FIG. 4A.

As illustrated in FIG. 14, the point cloud encoding method in the embodiments of the present disclosure includes the following.

In S201, M neighborhood blocks corresponding to a current point are determined in a reference picture of the current point.

The current point is a point in a point cloud whose attribute information is to be encoded, M being a positive integer.

As can be seen from the above, the point cloud includes geometry information and attribute information, and encoding the point cloud includes geometric encoding and attribute encoding. The embodiments of the present disclosure relate to the attribute encoding of the point cloud.

In the embodiments of the present disclosure, the point cloud attribute encoding is performed after the point cloud geometric encoding. That is, in the embodiments of the present disclosure, first, the geometry information of the point cloud is encoded. Next, the attribute information of the point cloud is encoded.

In some embodiments, when the attribute information of the point cloud is encoded, the point cloud is partitioned into multiple levels based on the geometry information of the point cloud, so as to encode attribute information of each point in each level in a level-by-level manner.

For example, the point cloud may be partitioned into multiple LOD levels based on the geometry information of the point cloud, and attribute information of each point in each LOD level is encoded.

In some embodiments, the point cloud is first sorted before the point cloud is partitioned into multiple levels. For example, based on geometry information of each point in the point cloud, the Morton code of each point in the point cloud is determined, and then the points in the point cloud are sorted based on the Morton codes to obtain a Morton-sorted point cloud.

In the embodiments of the present disclosure, the encoding process of the attribute information of each point in each level is basically the same. Taking a certain point in a certain level of the point cloud as an example, first, it is determined that N neighboring point(s) whose attribute information has been encoded of the current point are searched, where N is a positive integer. Next, the attribute information of the current point is predicted based on attribute information of the N neighboring point(s). For example, the attribute information of one neighboring point among the N neighboring point(s) is determined as the attribute prediction value of the current point, or the weighted average of the attribute information of the N neighboring point(s) is determined as the attribute prediction value of the current point.

When determining the N neighboring point(s) of the current point, the intra nearest neighbor search and/or the inter nearest neighbor search are generally involved.

For example, in some embodiments, only the intra nearest neighbor search mode is adopted to determine the N neighboring point(s) of the current point. In some embodiments, only the inter nearest neighbor search mode is adopted to determine the N neighboring point(s) of the current point.

For another example, in some embodiments, both the intra nearest neighbor search mode and the inter nearest neighbor search mode are adopted to determine the N neighboring point(s) of the current point.

At present, when performing the inter nearest neighbor search, the block-based inter fast search is adopted. For example, a point is determined in the reference picture based on an index of the current point, and at least one neighboring point of the current point is searched among points near the point in the reference picture. In order to improve searching speed of the neighboring points, relevant points in the reference picture are partitioned into multiple blocks, and an intra nearest neighbor is searched through a block-based mode. However, attribute values of points on a local area of a surface in the point cloud have a high correlation, while the current inter nearest neighbor search mode fails to utilize the spatial correlation of the point cloud, so that the determination of the inter (or referred to as inter-frame) neighboring points is inaccurate, resulting in poor attribute prediction performance.

In order to solve the above technical problem, in the embodiments of the present disclosure, when performing inter nearest neighbor search for attributes, the M neighborhood blocks corresponding to the current point is first determined in the reference picture of the current point; and the attribute prediction value of the current point is determined based on the attribute information of the points included in the M neighborhood blocks. That is, in the embodiments of the present disclosure, when determining the neighboring points of the current point, the spatial correlation of the points in the point cloud is taken into consideration, so as to improve the accuracy of determining the neighboring points. The attribute prediction value of the current point is determined based on the attribute information of the accurately determined neighboring points, and the prediction accuracy of the attribute prediction value may be enhanced, thereby improving the attribute prediction effect of the point cloud.

The specific process in which the encoding side determines the M neighborhood blocks corresponding to the current point in the reference picture of the current point is introduced below.

In some embodiments, when encoding the attribute information of the point cloud, the encoding side may not perform level partitioning on the point cloud. As such, the current point may be understood as any point in the point cloud whose attribute information is to be encoded.

In some embodiments, when encoding the corresponding attribute information, the encoding side performs level partitioning on the point cloud, such as performing an LOD level partitioning on the point cloud. As such, the current point may be understood as any point in the LOD level of the point cloud whose attribute information is to be encoded.

When the attribute information of the current point is encoded, the reference picture of the current point is first determined. The attribute information of the reference picture has been decoded.

In the embodiments of the present disclosure, the reference picture (or referred to as reference frame) of the current point may be understood as a reference picture of a current picture (or referred to as current frame) where the current point is located.

The number of reference pictures of the current point is not limited in the embodiments of the present disclosure. That is, the current point has one or more reference pictures.

In some embodiments, the reference picture of the current point includes a forward reference picture of the current picture.

In some embodiments, the reference picture of the current point includes a back ward reference picture of the current picture.

In some embodiments, the reference picture of the current point includes a forward reference picture of the current picture and a backward reference picture of the current picture.

Next, the encoding side determines the M neighborhood blocks corresponding to the current point in the reference picture of the current point.

In some embodiments, before determining the M neighborhood blocks corresponding to the current point in the reference picture of the current point, the encoding side first performs block partitioning on the point cloud, so as to determine the M neighborhood blocks corresponding to the current point among blocks included in the reference picture.

In a possible implementation, before encoding the attribute information of the point cloud, the encoding side performs block partitioning on the point cloud based on the encoded geometry information of the point cloud, to partition the point cloud into multiple sub-blocks. During the subsequent encoding of the attribute information of the point cloud, inter neighborhood blocks of the current point are searched based on the partitioned point cloud sub-blocks.

In a possible implementation, when encoding the attribute information of each picture of point cloud (or referred to as each frame of point cloud), the encoding side performs block partitioning on the point cloud once. When performing attribute encoding on the point in each picture of the point cloud, the inter neighborhood blocks of the point in the picture are searched among the sub-blocks of the point cloud obtained from partitioning the picture. For example, when performing attribute encoding on the first picture of the point cloud, the encoding side performs block partitioning on the point cloud. When encoding any point in the first picture of the point cloud, the encoding side searches for the inter neighborhood blocks of the point among the point cloud sub-blocks obtained from the first partitioning. When performing attribute encoding on the second picture of the point cloud, the encoding side re-performs block partitioning on the point cloud. When encoding any point in the second picture of the point cloud, the encoding side searches for the inter neighborhood blocks of the point among the point cloud sub-blocks obtained from the second partitioning, and so on. It is to be noted that the block partitioning manner for the point cloud may be the same or different each time, which is not limited in the embodiments of the present disclosure.

In a possible implementation, when encoding the attribute information of each point in the point cloud, the encoding side performs block partitioning on the point cloud once. For example, when performing attribute encoding on point 1 in the point cloud, the encoding side performs block partitioning on the point cloud, and then searches for the inter neighborhood blocks of the point 1 among the point cloud sub-blocks obtained from the first partitioning. When performing attribute encoding on point 2 in the point cloud, the encoding side re-performs block partitioning on the point cloud, and then searches for the inter neighborhood blocks of the point 2 among the point cloud sub-blocks obtained from the second partitioning, and so on. It is to be noted that the block partitioning manner for the point cloud may be the same or different each time, which is not limited in the embodiments of the present disclosure.

The specific manner of performing block partitioning on the point cloud is not limited in the embodiments of the present disclosure. For example, the specific manner may be binary tree partitioning, quadtree partitioning, hextree partitioning, octree partitioning, and so on.

The specific manner in which the encoding side determines the M neighborhood blocks corresponding to the current point in the reference picture of the current point is not limited in the embodiments of the present disclosure.

In some embodiments, a point whose index is closest to the index of the current point is determined in the reference picture based on the index of the current point, and a block where the point is located is determined (i.e., a spatial block of the point) in the reference picture. M neighborhood blocks of the spatial block are searched in the reference picture. For example, M neighborhood blocks of the spatial block sharing a face, an edge or a vertex with the spatial block are searched in the reference picture, and the M neighborhood blocks of the spatial block are determined as the M neighborhood blocks of the current point. For example, the point 1 whose index is closest to the index of the current point is determined in the reference picture based on the index of the current point, and a spatial block 1 of the point 1 is determined in the reference picture. Next, M neighborhood blocks sharing a face, an edge or a vertex with the spatial block 1 are searched among blocks included in the reference picture, so as to determine the M neighborhood blocks as the M neighborhood blocks of the current point.

In some embodiments, the encoding side determines the M neighborhood blocks corresponding to the current point in the reference picture of the current point through following steps.

In S201-A, a first spatial block of the current point is determined in the current picture.

In S201-B, a collocated block of the first spatial block is determined in a reference picture.

In S201-C, M neighborhood blocks of the collocated block are determined in the reference picture, and the M neighborhood blocks of the collocated block are taken as the M neighborhood blocks corresponding to the current point.

In the embodiments, as illustrated in FIG. 10, when the M neighborhood blocks corresponding to the current point are determined in the reference picture, the spatial block where the current point is located is first determined in the current picture, and the spatial block is recorded as the first spatial block. Next, the collocated block of the first spatial block is determined in the reference picture, and then, the M neighborhood blocks of the collocated block are determined in the reference picture. For example, as illustrated in FIG. 11, assuming that a block with dark wireframe is the collocated block, the collocated block has 6 co-planar blocks, 12 co-edge blocks and 8 co-vertex blocks. The M neighborhood blocks of the collocated block are determined from these 6 co-planar blocks, 12 co-edge blocks and 8 co-vertex blocks. The M neighborhood blocks of the collocated block are determined as the M neighborhood blocks corresponding to the current point.

In the S201-B, the specific implementation of determining the collocated block of the first spatial block in the reference picture includes, but is not limited to, the following.

Manner I: the S201-B includes step S201-B-a as follows.

In S201-B-a, the collocated block of the first spatial block is determined in the reference picture based on position information of the first spatial block.

In the manner I, the encoding side may directly determine the collocated block in the reference picture based on the position information of the first spatial block. In this way, the collocated block of the first spatial block may be determined quickly, so as to improve the attribute encoding efficiency.

The specific manner in which the encoding side determines the collocated block of the first spatial block in the reference picture based on the position information of the first spatial block is not limited in the embodiments of the present disclosure.

In an example, the encoding side determines, based on the position information of the first spatial block, a block in the reference picture whose position information is consistent with the position information of the first spatial block as the collocated block of the first spatial block. Assuming that position coordinates of the first spatial block in the current picture are (x0, y0, z0), the block with the position coordinates (x0, y0, z0) is searched in the reference picture, and the block is determined as the collocated block of the first spatial block in the reference picture.

The specific expression form of the position information of the first spatial block is not limited in the embodiments of the present disclosure. For example, as illustrated in FIG. 12, the position coordinates (x0, y0, z0) of the first spatial block in the current picture may be coordinate values of the lower left corner (or other positions) of the first spatial block. Therefore, the block whose lower left corner position coordinates (x0, y0, z0) in the reference picture is determined as the collocated block of the first spatial block in the reference picture.

In another example, the encoding side determines, based on the position information of the first spatial block, a block in the reference picture whose distance from the first spatial block meets a preset requirement as the collocated block of the first spatial block.

The preset requirement is not limited in the embodiments of the present disclosure. For example, the preset requirement is that the distance is minimum. That is, the encoding side determines, based on the position information of the first spatial block, the distance between each block in the reference picture and the first spatial block, selects a block with the minimum distance and determines the block as the collocated block of the first spatial block in the reference picture. For another example, the preset requirement is that the distance is less than or equal to a preset value. In this way, the encoding side determines, based on the position information of the first spatial block, the distance between each block in the reference picture and the first spatial block, selects a block whose distance is less than or equal to the preset value, and determines the block as the collocated block of the first spatial block in the reference picture.

For example, the encoding side may determine the distance between the block in the reference picture and the first spatial block based on the above formula (24).

The size of the collocated block is not limited in the embodiments of the present disclosure.

In some embodiments, when the encoding side performs block partitioning on the point cloud and the sizes of the partitioned point cloud sub-blocks are all consistent, the size of the collocated block of the first spatial block determined by the encoding side is consistent with the size of the first spatial block.

In some embodiments, when the encoding side performs block partitioning on the point cloud and the sizes of the partitioned point cloud sub-blocks are not completely consistent, the S201-B-a includes step S201-B-al as follows.

In S201-B-al, the encoding side determines the collocated block of the first spatial block in the reference picture based on the position information of the first spatial block and the size of the first spatial block.

For example, a block in the reference picture whose position information is consistent with the position information of the first spatial block and whose size is consistent with the size of the first spatial block is determined as the collocated block of the first spatial block.

In some embodiments, when there is no block in the reference picture whose position information is consistent with the position information of the first spatial block and whose size is consistent with the size of the first spatial block, the encoding side searches for a block in the reference picture whose position information is closest to the position information of the first spatial block and whose size is closest to the size of the first spatial block based on the position information and the size of the first spatial block, and determines the block as the collocated block of the first spatial block in the reference picture.

In addition to determining the collocated block of the first spatial block in the reference picture using the manner I, the encoding side may also determine the collocated block of the first spatial block using the manner II as follows.

Manner II: the S201-B includes steps S201-B-b1 to S201-B-b3 as follows.

In S201-B-b1, a first reference point corresponding to the current point is determined in the reference picture.

In S201-B-b2, a second spatial block of the first reference point is determined in the reference picture.

In S201-B-b3, the second spatial block is determined as the collocated block of the first spatial block.

In the manner II, as illustrated in FIG. 13, when determining the collocated block of the first spatial block in the reference picture, the encoding side first determines the first reference point corresponding to the current point in the reference picture; then, determines the second spatial block of the first reference point in the reference picture; and finally, determines the second spatial block as the collocated block of the first spatial block in the reference picture.

The specific manner in which the encoding side determines the first reference point corresponding to the current point in the reference picture is not limited in the embodiments of the present disclosure.

In a possible implementation, the encoding side determines the first reference point in the reference picture based on the position information of the current point in the current picture. For example, the encoding side determines a point in the reference picture whose position information is consistent with the position information of the current point in the current picture as the first reference point of the current point in the reference picture. For another example, when there is no point in the reference picture whose position information is consistent with the position information of the current point in the current picture, the distance between the position information of each point in the reference picture and the position information of the current point in the current picture is determined, and the point in the reference picture with the minimum distance is determined as the first reference point of the current point in the reference picture.

In a possible implementation, the first reference point is determined in the reference picture based on an index of the current point.

When performing attribute encoding on the point cloud, the encoding side determines the index of each point in the point cloud, for example, determining a Morton code of each point in the point cloud, and records the Morton code as the index of the point. Next, the point cloud is sorted based on the index of each point in the point cloud, and LOD partitioning is performed on the sorted point cloud. It may be seen that each point in the point cloud has an index, and thus, the encoding side may determine the first reference point corresponding to the current point in the reference picture according to the index of the current point.

For example, a point in the reference picture whose index is the same as the index of the current point is determined as the first reference point corresponding to the current point in the reference picture.

For another example, a point among points included in the reference picture whose index is a first one greater than or equal to the index of the current point is determined as the first reference point corresponding to the current point in the reference picture.

Optionally, the index is the Morton code index. That is, the encoding side determines the point in the reference picture whose Morton code index is the same as the Morton code index of the current point as the first reference point corresponding to the current point in the reference picture. Alternatively, the encoding side determines the point among the points included in the reference picture whose Morton code index is a first one greater than or equal to the Morton code index of the current point as the first reference point corresponding to the current point in the reference picture.

After determining the first reference point corresponding to the current point in the reference picture based on the above steps, the encoding side determines the second spatial block of the first reference point in the reference picture.

In the manner II, there is no limitation on the size of the second spatial block.

In some embodiments, when the encoding side performs block partitioning on the point cloud and the sizes of the partitioned point cloud sub-blocks are all consistent, the size of the second spatial block determined by the encoding side is consistent with the size of the first spatial block.

In some embodiments, when the encoding side performs block partitioning on the point cloud and the sizes of the partitioned point cloud sub-blocks are not completely consistent, the S201-B-b2 includes step S201-B-b21 as follows.

In S201-B-b21, the encoding side determines the second spatial block of the first reference point in the reference picture based on the size of the first spatial block.

For example, when the size of the spatial block where the first reference point is located is consistent with the size of the first spatial block, the spatial block where the first reference point is located is directly determined as the second spatial block of the first reference point. As such, the size of the second spatial block is consistent with the size of the first spatial block.

For another example, when the size of the spatial block where the first reference point is located is inconsistent with the size of the first spatial block, the spatial block where the first reference point is located may be determined as the second spatial block of the first reference point. As such, the size of the second spatial block is inconsistent with the size of the first spatial block.

For another example, when the size of the spatial block where the first reference point is located is inconsistent with the size of the first spatial block, a block among the blocks near the first reference point whose size is consistent with or closest to the size of the first spatial block is searched and determined as the second spatial block of the first reference point based on the first reference point. As such, the size of the second spatial block is substantially consistent with the size of the first spatial block.

In the manner II, after determining the second spatial block of the first reference point in the reference picture based on the above steps, the encoding side determines the second spatial block as the collocated block of the first spatial block in the reference picture.

After determining the collocated block of the first spatial block in the reference picture based on the above method, the encoding side performs step S201-C to determine the M neighborhood blocks of the collocated block in the reference picture, and takes the M neighborhood blocks of the collocated block as the M neighborhood blocks corresponding to the current point.

For example, the encoding side determines M co-planar neighborhood blocks of the collocated block (i.e., M neighborhood blocks sharing a face with the collocated block) in the reference picture, and determines the M co-planar neighborhood blocks as the M neighborhood blocks corresponding to the current point.

For another example, the encoding side determines M co-edge neighborhood blocks of the collocated block (i.e., M neighborhood blocks sharing an edge with the collocated block) in the reference picture, and determines the M co-edge neighborhood blocks as the M neighborhood blocks corresponding to the current point.

For another example, the encoding side determines M co-vertex neighborhood blocks of the collocated block (i.e., M neighborhood blocks sharing a vertex with the collocated block) in the reference picture, and determines the M co-vertex neighborhood blocks as the M neighborhood blocks corresponding to the current point.

For another example, the encoding side determines M co-planar and co-edge neighborhood blocks of the collocated block (i.e., M neighborhood blocks sharing a face or edge with the collocated block) in the reference picture, and determines the M co-planar and co-edge neighborhood blocks as the M neighborhood blocks corresponding to the current point.

For another example, the encoding side determines M co-planar and co-vertex neighborhood blocks of the collocated block (i.e., M neighborhood blocks sharing a face or vertex with the collocated block) in the reference picture, and determines the M co-planar and co-vertex neighborhood blocks as the M neighborhood blocks corresponding to the current point.

For another example, the encoding side determines M co-edge and co-vertex neighborhood blocks of the collocated block (i.e., M neighborhood blocks sharing an edge or vertex with the collocated block) in the reference picture, and determines the M co-edge and co-vertex neighborhood blocks as the M neighborhood blocks corresponding to the current point.

For another example, the encoding side determines M co-planar, co-edge and co-vertex neighborhood blocks of the collocated block (i.e., M neighborhood blocks sharing a face, edge or vertex with the collocated block) in the reference picture, and determines the M co-planar, co-edge and co-vertex neighborhood blocks as the M neighborhood blocks corresponding to the current point.

After determining the M neighborhood blocks corresponding to the current point based on the above steps, the encoding side performs the following step S102.

In S202, an attribute prediction value of the current point is determined based on attribute information of points included in the M neighborhood blocks.

In the embodiments of the present disclosure, based on the above steps, the encoding side determines the M neighborhood blocks corresponding to the current point in the reference picture, and then performs prediction on the attribute information of the current point based on the attribute information of the points included in the M inter neighborhood blocks. The points included in the M inter neighborhood blocks have correlation with the current point spatially, and then, when prediction is performed on the attribute information of the current point based on the attribute information of the points included in the M inter neighborhood blocks, the prediction accuracy may be enhanced, thereby improving the accuracy of attribute prediction of the point cloud and improving the attribute encoding effect of the point cloud.

The specific manner in which the encoding side determines the attribute prediction value of the current point based on the attribute information of the points included in the M neighborhood blocks is not limited in the embodiments of the present disclosure.

In some embodiments, the encoding side may determine the attribute prediction value of the current point based on the attribute information of all points included in the M neighborhood blocks. Assuming that the M neighborhood blocks include K points in total, the attribute prediction value of the current point is determined based on the attribute information of the K points.

For example, the average value of the attribute information of the K points is determined as the attribute prediction value of the current point.

For another example, the weighted average value of the attribute information of the K points is determined as the attribute prediction value of the current point. For example, the weight corresponding to each of the K points is the inverse of the distance from the point to the current point.

In some embodiments, the S202 includes following steps.

In S202-A1, at least one first neighboring point is determined among the points included in the M neighborhood blocks.

In S202-A2, the attribute prediction value of the current point is determined based on attribute information of the at least one first neighboring point.

In the implementation, based on the above steps, the encoding side determines the M neighborhood blocks corresponding to the current point in the reference picture; selects at least one neighboring point from the points included in the M neighborhood blocks and records the at least neighboring point as the first neighboring point; and finally, predicts the attribute information of the current point based on the attribute information of the selected at least one first neighboring point.

For example, it is assumed that the M neighborhood blocks include K points in total, K being a positive integer, and it is assumed that the upper-layer syntax specifies that the number of nearest neighbor points through inter searched is N. It is assumed that K is greater than N, the encoding side selects N points from the K points included in the M neighborhood blocks as the first neighboring points of the current point, and determines the attribute prediction value of the current point based on the attribute information of the N first neighboring points.

In an example, if K=1, the encoding side determines a point that is uniquely included in the M neighborhood blocks as the first neighboring point of the current point.

In an example, if K is greater than 1 and greater than N, the encoding side selects N points from the K points as N first neighboring points of the current point.

The specific manner in which the encoding side selects the N points from the K points is not limited in the embodiments of the present disclosure.

For example, since the geometry information of the point cloud has been encoded, the geometry information of each point in the point cloud is known. Therefore, in the embodiments of the present disclosure, the encoding side may determine, based on the geometry information of each of the K points included in the M neighborhood blocks and the geometry information of the current point, the distance between each of the K points and the current point; and select N points from the K points based on the distance. For example, N points closest to the current point are selected from the K points as the N first neighboring points of the current point.

After determining the at least one first neighboring point of the current point among the points included in the M inter neighborhood blocks corresponding to the current point based on the above steps, the encoding side determines the attribute prediction value of the current point based on the attribute information of the at least one first neighboring point.

For example, in a case where the at least one first neighboring point includes one first neighboring point, the attribute information of the first neighboring point is determined as the attribute prediction value of the current point.

For another example, in a case where the at least one first neighboring point includes multiple first neighboring points, the average value of the attribute information of the multiple first neighboring points is determined as the attribute prediction value of the current point.

For another example, in a case where the at least one first neighboring point includes multiple first neighboring points, the weighted average value of the attribute information of the multiple first neighboring points is determined as the attribute prediction value of the current point.

For example, the encoding side determines the attribute prediction value of the current point based on the above formula (25).

The processes in which the encoding side determines the M inter neighborhood blocks of the current point in the reference picture and performs prediction on the attribute information of the current point based on the attribute information of the points included in the M inter neighborhood blocks are introduced in the above embodiments.

In some embodiments, when the number of the first neighboring points determined by the encoding side among the points included in the M neighborhood blocks does not meet a first preset number, the method in the embodiments of the present disclosure further include steps 11 and 12 as follows.

In step 11: a first determination mode is adopted to determine Q second neighboring points of the current point, Q being an integer.

In step 22: the attribute prediction value of the current point is determined based on attribute information of the Q second neighboring points.

The first determination mode is not limited in the embodiments of the present disclosure.

For example, the first determination mode is an intra nearest neighbor search mode and/or a block-based inter nearest neighbor search mode.

In the present embodiments, it is assumed that the number of the first neighboring points required to be determined by the encoding side is the first preset number R, the number of the points included in the M neighborhood blocks is K, and the number of the first neighboring points determined among the K points included in the M neighborhood blocks is N. If N is less than R, the encoding side adopts the first determination mode to determine the Q second neighboring points of the current point.

For example, the encoding side adopts the intra nearest neighbor search mode to search for the Q second neighboring points of the current point in the current picture.

For another example, the encoding side adopts the block-based inter nearest neighbor search mode to search for the Q second neighboring points of the current point in the reference picture.

For another example, the encoding side adopts the intra nearest neighbor search mode to search for at least one second neighboring point of the current point in the current picture, and adopts the block-based inter nearest neighbor search mode to search for at least one second neighboring point of the current point in the reference picture, so as to search for the Q second neighboring points of the current point in intra-picture and inter-picture (i.e., in intra-frame and inter-frame).

Next, the encoding side determines the attribute prediction value of the current point based on the attribute information of the Q second neighboring points.

In an example, the encoding side determines the attribute prediction value of the current point based on the attribute information of the Q second neighboring points only, without considering the first neighboring point(s).

For example, the average value of the attribute information of the Q second neighboring points is determined as the attribute prediction value of the current point. For another example, the weighted average value of the attribute information of the Q second neighboring points is determined as the attribute prediction value of the current point. Exemplarily, the weighted average formula may refer to the above formula (25).

In another example, the attribute prediction value of the current point is determined based on the attribute information of the Q second neighboring points and the attribute information of the points included in the M neighborhood blocks.

For example, the average value of the attribute information of the Q second neighboring points and the first neighboring point(s) determined above is determined as the attribute prediction value of the current point. For another example, the weighted average of the attribute information of the Q second neighboring points and the first neighboring point(s) determined above is determined as the attribute prediction value of the current point. For example, the weighted average formula may refer to the above formula (25).

In some embodiments, if the point cloud is a sparse point cloud, there may be no neighborhood block corresponding to the current point in the reference picture. As such, the method in the embodiments of the present disclosure further includes steps 21 and 22 as follows.

In step 21: in response to no neighborhood block corresponding to the current point existing in the reference picture, the encoding side adopts a first determination mode to determine P second neighboring points of the current point, P being an integer.

In step 22: the attribute prediction value of the current point is determined based on attribute information of the P second neighboring points.

In the embodiments of the present disclosure, if the encoding side fails to determine the neighborhood block corresponding to the current point in the reference picture based on the above steps, the encoding side adopts the first determination mode to determine the P second neighboring points of the current point.

For example, the encoding side adopts the intra nearest neighbor search mode to search for the P second neighboring points of the current point in the current picture.

For another example, the encoding side adopts the block-based inter nearest neighbor search mode to search for the P second neighboring points of the current point in the reference picture.

For another example, the encoding side adopts the intra nearest neighbor search mode to search for at least one second neighboring point of the current point in the current picture, and adopts the block-based inter nearest neighbor search mode to search for at least one second neighboring point of the current point in the reference picture, so as to search for the P second neighboring points of the current point in intra-picture and inter-picture (i.e., in intra-frame and inter-frame).

Next, the encoding side determines the attribute prediction value of the current point based on the attribute information of the P second neighboring points. For example, the average value of the attribute information of the P second neighboring points is determined as the attribute prediction value of the current point. For another example, the weighted average value of the attribute information of the P second neighboring points is determined as the attribute prediction value of the current point. For example, the weighted average formula may refer to the above formula (25).

In some embodiments, when the number of the second neighboring points of the current point determined by the encoding side based on the above steps does not meet a second preset number, the method in the embodiments of the present disclosure further includes the following.

In step 31: a second reference point corresponding to the current point is determined in the reference picture.

In step 32: at least one third neighboring point of the current point is determined in the reference picture based on the second reference point and a preset search range.

In step 33: the attribute prediction value of the current point is determined based on attribute information of the at least one third neighboring point.

The specific manner in which the encoding side determines the second reference point corresponding to the current point in the reference picture is not limited in the embodiments of the present disclosure.

For example, the encoding side determines a point in the reference picture whose position information is consistent with the position information of the current point in the current picture as the second reference point.

For another example, the encoding side determines a point among the points included in the reference picture whose index is a first one greater than or equal to the index of the current point as the second reference point.

Optionally, the above index is the Morton code index.

After determining the second reference point j corresponding to the current point in the reference picture, the encoding side determines the at least one third neighboring point of the current point in the reference picture based on the second reference point j and the preset search range searchRange.

For example, the encoding side determines the at least one third neighboring point of the current point within the range of [j-searchRange, j] of the reference picture.

For another example, the encoding side determines the at least one third neighboring point of the current point within the range of [j, j+searchRange] of the reference picture.

For another example, the encoding side determines the at least one third neighboring point of the current point within the range of [j-searchRange, j+searchRange] of the reference picture.

The encoding side determines the at least one third neighboring point of the current point in the reference picture, and then, determines the attribute prediction value of the current point based on the at least one third neighboring point.

In an example, the encoding side determines the attribute prediction value of the current point based on the at least one third neighboring point determined above only. For example, the average value or weighted average value of the attribute information of the at least one third neighboring point is determined as the attribute prediction value of the current point.

In an example, the encoding side determines the attribute prediction value of the current point based on the at least one second neighboring point and the at least one third neighboring point determined above. For example, the average value or weighted average value of the attribute information of the at least one second neighboring point and the at least one third neighboring point is determined as the attribute prediction value of the current point.

In an example, the encoding side determines the attribute prediction value of the current point based on the at least one first neighboring point, the at least one second neighboring point and the at least one third neighboring point determined above. For example, the average value or weighted average value of the attribute information of the at least one first neighboring point, the at least one second neighboring point and the at least one third neighboring point is determined as the attribute prediction value of the current point.

As can be seen from the above, the method proposed in the embodiments of the present disclosure in which the neighboring points are determined in inter-picture (i.e., inter-frame) based on the geometry information (i.e., the M neighborhood blocks corresponding to the current point are determined in inter-picture, and the at least one first neighboring point of the current point is determined based on the points included in the M neighborhood blocks) may be combined with the existing method in which the neighboring points are determined, so as to improve the accuracy of determining the neighboring points, thereby improving the attribute prediction effect of the point cloud.

According to the point cloud encoding method provided in the embodiments of the present disclosure, when performing intra nearest neighbor search for attributes, the M neighborhood blocks corresponding to the current point are first determined in the reference picture of the current point; and the attribute prediction value of the current point is determined based on the attribute information of the points included in the M neighborhood blocks. That is, in the embodiments of the present disclosure, when determining the neighboring points of the current point, the spatial correlation between the point cloud attributes is taken into consideration, so as to improve the accuracy of determining the neighboring points. When performing prediction on the attribute information of the current point based on the attribute information of the accurately determined neighboring points, the accuracy of attribute prediction may be enhanced, thereby improving the encoding effect of the attribute information of the point cloud.

The preferred implementations of the present disclosure are described in detail above in conjunction with the drawings. However, the present disclosure is not limited to the specific details in the above implementations. Within the technical concept of the present disclosure, various simple modifications may be made to the technical solutions of the present disclosure, and these simple modifications all fall within the protection scope of the present disclosure. For example, if there is no contradiction, various specific technical features described in the above specific implementations may be combined in any appropriate manner. In order to avoid unnecessary repetition, various possible combinations are not further described in the present disclosure. For another example, the various implementation of the present disclosure may be arbitrarily combined, and as long as they do not violate the concept of the present disclosure, these combinations should also be regarded as the contents disclosed in the present disclosure.

It should also be understood that in the various method embodiments of the present disclosure, values of the serial numbers of the above-mentioned processes does not mean the order of execution. The execution order of each process should be determined by its function and internal logic, and should not constitute any limitation on the implementation process of the embodiments of the present disclosure. In addition, in the embodiments of the present disclosure, the term “and/or” is merely an association relationship to describe associated objects, which indicates that three types of relationships may exist. Exemplarily, A and/or B may represent three cases: A exists alone, both A and B exist, and B exists alone. In addition, the character “/” here generally indicates that the previous and next related objects are in an “or” relationship.

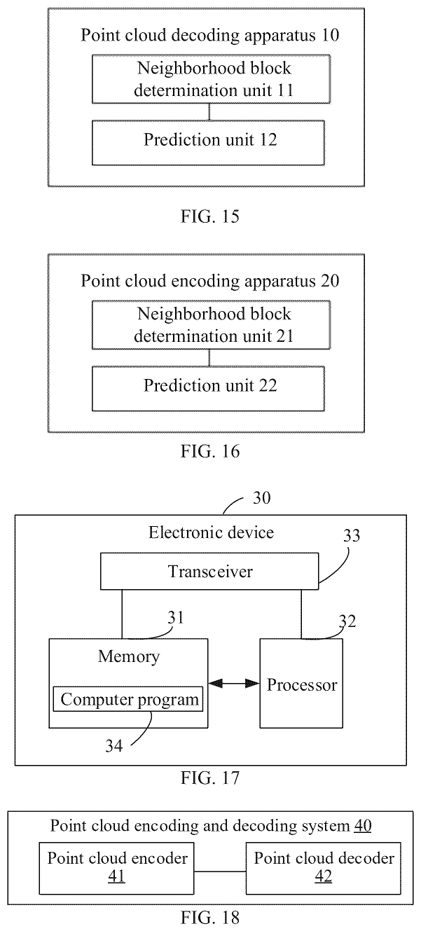

The method embodiments of the present disclosure are described above in detail in conjunction with FIG. 9 to FIG. 14, and the apparatus embodiments of the present disclosure are described in detail below in conjunction with FIG. 15 and FIG. 16.

FIG. 15 is a schematic block diagram of a point cloud decoding apparatus provided in the embodiments of the present disclosure.

As illustrated in FIG. 20, the point cloud decoding apparatus 10 may include:
a neighborhood block determination unit 11, configured to determine M neighborhood blocks corresponding to a current point in a reference picture of the current point, where the current point is a point in a point cloud whose attribute information is to be decoded, M being a positive integer; and
a prediction unit 12, configured to determine an attribute prediction value of the current point based on attribute information of points included in the M neighborhood blocks.

In some embodiments, the neighborhood block determination unit 11 is specifically configured to determine a first spatial block of the current point in a current picture; determine a collocated block of the first spatial block in the reference picture; and determine M neighborhood blocks of the collocated block in the reference picture as the M neighborhood blocks corresponding to the current point.

In some embodiments, the neighboring block determination unit 11 is specifically configured to determine the collocated block of the first spatial block in the reference picture based on position information of the first spatial block.

In some embodiments, the neighboring block determination unit 11 is specifically configured to determine the collocated block of the first spatial block in the reference picture based on the position information of the first spatial block and a size of the first spatial block.

In some embodiments, the neighborhood block determination unit 11 is specifically configured to determine a block in the reference picture whose position information is consistent with the position information of the first spatial block in the current picture and whose size is consistent with the size of the first spatial block as the collocated block of the first spatial block.

In some embodiments, the neighborhood block determination unit 11 is specifically configured to determine a first reference point corresponding to the current point in the reference picture; determine a second spatial block of the first reference point in the reference picture; and determine the second spatial block as the collocated block of the first spatial block.

In some embodiments, the neighborhood block determination unit 11 is specifically configured to determine the first reference point in the reference picture based on an index of the current point.

In some embodiments, the neighborhood block determination unit 11 is specifically configured to determine a point among points included in the reference picture whose index is a first one greater than or equal to the index of the current point as the first reference point.

Optionally, the index is a Morton code index.

In some embodiments, the neighborhood block determination unit 11 is specifically configured to determine the second spatial block of the first reference point in the reference picture based on a size of the first spatial block.

Optionally, a size of the second spatial block is consistent with the size of the first spatial block.

In some embodiments, the prediction unit 12 is specifically configured to determine at least one first neighboring point among the points included in the M neighborhood blocks; and determine the attribute prediction value of the current point based on attribute information of the at least one first neighboring point.

In some embodiments, the prediction unit 12 is further configured to adopt, in response to no neighborhood block corresponding to the current point existing in the reference picture, a first determination mode to determine P second neighboring points of the current point, P being an integer; and determine the attribute prediction value of the current point based on attribute information of the P second neighboring points.

In some embodiments, the prediction unit 12 is further configured to adopt, in response to a number of first neighboring points determined among the points included in the M neighborhood blocks not meeting a first preset number, a first determination mode to determine Q second neighboring points of the current point, Q being an integer; and determine the attribute prediction value of the current point based on attribute information of the Q second neighboring points.

In some embodiments, the prediction unit 12 is specifically configured to determine the attribute prediction value of the current point based on the attribute information of the Q second neighboring points and the attribute information of the points included in the M neighborhood blocks.

In some embodiments, the first determination mode is an intra nearest neighbor search mode and/or a block-based inter nearest neighbor search mode.

In some embodiments, the prediction unit 12 is further configured to determine, in response to a number of determined second neighboring points of the current point not meeting a second preset number, a second reference point corresponding to the current point in the reference picture; determine at least one third neighboring point of the current point in the reference picture based on the second reference point and a preset search range; and determine the attribute prediction value of the current point based on attribute information of the at least one third neighboring point.

In some embodiments, the prediction unit 12 is specifically configured to determine a point among points included in the reference picture whose index is a first one greater than or equal to an index of the current point as the second reference point.

In some embodiments, the prediction unit 12 is further configured to perform block partitioning on the point cloud before determining the M neighborhood blocks corresponding to the current point in the reference picture of the current point; and determine the M neighborhood blocks corresponding to the current point among blocks included in the reference picture.

In some embodiments, the current point is any point in a level-of-detail (LOD) level of the point cloud whose attribute information is to be decoded, and the LOD level of the point cloud is obtained by performing LOD partitioning on the point cloud.

It should be understood that the apparatus embodiments and the method embodiments may correspond to each other, and similar descriptions may refer to the method embodiments, which will not be repeated here for avoiding repetitions. Specifically, the point cloud decoding apparatus 10 illustrated in FIG. 15 may correspond to the corresponding subject that performs the point cloud decoding method in the embodiments of the present disclosure, and the aforementioned and other operations and/or functions of each unit in the point cloud decoding apparatus 10 are respectively for implementing the corresponding processes in the point cloud decoding method, which will not be repeated here for the sake of brevity.

FIG. 16 is a schematic block diagram of the point cloud encoding apparatus provided in the embodiments of the present disclosure.

As illustrated in FIG. 16, the point cloud encoding apparatus 20 includes:
a neighborhood block determination unit 21, configured to determine M neighborhood blocks corresponding to a current point in a reference picture of the current point, where the current point is a point in a point cloud whose attribute information is to be encoded, M being a positive integer; and
a prediction unit 22, configured to determine an attribute prediction value of the current point based on attribute information of points included in the M neighborhood blocks.

In some embodiments, the neighborhood block determination unit 21 is specifically configured to determine a first spatial block of the current point in a current picture; determine a collocated block of the first spatial block in the reference picture; and determine M neighborhood blocks of the collocated block in the reference picture as the M neighborhood blocks corresponding to the current point.

In some embodiments, the neighboring block determination unit 21 is specifically configured to determine the collocated block of the first spatial block in the reference picture based on position information of the first spatial block.

In some embodiments, the neighboring block determination unit 21 is specifically configured to determine the collocated block of the first spatial block in the reference picture based on the position information of the first spatial block and a size of the first spatial block.

In some embodiments, the neighborhood block determination unit 21 is specifically configured to determine a block in the reference picture whose position information is consistent with the position information of the first spatial block and whose size is consistent with the size of the first spatial block as the collocated block of the first spatial block.

In some embodiments, the neighborhood block determination unit 21 is specifically configured to determine a first reference point corresponding to the current point in the reference picture; determine a second spatial block of the first reference point in the reference picture; and determine the second spatial block as the collocated block of the first spatial block.

In some embodiments, the neighborhood block determination unit 21 is specifically configured to determine the first reference point in the reference picture based on an index of the current point.

In some embodiments, the neighborhood block determination unit 21 is specifically configured to determine a point among points included in the reference picture whose index is a first one greater than or equal to the index of the current point as the first reference point.

Optionally, the index is a Morton code index.

In some embodiments, the neighborhood block determination unit 21 is specifically configured to determine the second spatial block of the first reference point in the reference picture based on a size of the first spatial block.

Optionally, a size of the second spatial block is consistent with the size of the first spatial block.

In some embodiments, the prediction unit 22 is specifically configured to determine at least one first neighboring point among the points included in the M neighborhood blocks; and determine the attribute prediction value of the current point based on attribute information of the at least one first neighboring point.

In some embodiments, the prediction unit 22 is further configured to adopt, in response to no neighborhood block corresponding to the current point existing in the reference picture, a first determination mode to determine P second neighboring points of the current point, P being an integer; and determine the attribute prediction value of the current point based on attribute information of the P second neighboring points.

In some embodiments, the prediction unit 22 is further configured to adopt, in response to a number of first neighboring points determined among the points included in the M neighborhood blocks not meeting a first preset number, a first determination mode to determine Q second neighboring points of the current point, Q being an integer; and determine the attribute prediction value of the current point based on attribute information of the Q second neighboring points.

In some embodiments, the prediction unit 22 is further configured to determine the attribute prediction value of the current point based on the attribute information of the Q second neighboring points and the attribute information of the points included in the M neighborhood blocks.

In some embodiments, the first determination mode is an intra nearest neighbor search mode and/or a block-based inter nearest neighbor search mode.

In some embodiments, the prediction unit 22 is further configured to determine, in response to a number of determined second neighboring points of the current point not meeting a second preset number, a second reference point corresponding to the current point in the reference picture; determine at least one third neighboring point of the current point in the reference picture based on the second reference point and a preset search range; and determine the attribute prediction value of the current point based on attribute information of the at least one third neighboring point.

In some embodiments, the prediction unit 22 is further configured to determine a point among points included in the reference picture whose index is a first one greater than or equal to an index of the current point as the second reference point.

In some embodiments, the prediction unit 22 is further configured to perform block partitioning on the point cloud before determining the M neighborhood blocks corresponding to the current point in the reference picture of the current point; and determine the M neighborhood blocks corresponding to the current point among blocks included in the reference picture.

In some embodiments, the current point is any point in a level-of-detail (LOD) level of the point cloud whose attribute information is to be encoded, and the LOD level of the point cloud is obtained by performing LOD partitioning on the point cloud.

It should be understood that the apparatus embodiments and the method embodiments may correspond to each other, and similar descriptions may be referred to these of the method embodiments, which will not be repeated here to avoid repetition. Specifically, the point cloud encoding apparatus 20 illustrated in FIG. 16 may correspond to the corresponding subject that performs the point cloud encoding method in the embodiments of the present disclosure, and the aforementioned and other operations and/or functions of each unit in the point cloud encoding apparatus 20 are respectively for implementing corresponding processes in the point cloud encoding method, which will not be repeated here for the sake of brevity.

The apparatus and the system of the embodiments of the present disclosure are described above from the perspective of functional units in conjunction with the accompanying drawings. It should be understood that the functional units may be implemented in the form of hardware, or may be implemented by instructions in the form of software, or may be implemented by a combination of hardware units and software units. Specifically, each step of the method embodiments in the embodiments of the present disclosure may be completed by the hardware integrated logic circuit and/or software instructions in the processor. The steps of the method disclosed in the embodiments of the present disclosure may be directly reflected as being performed by a hardware decoding processor, or being performed by a combination of hardware units and software units in the decoding processor. Optionally, the software unit may be located in a mature storage medium in the art, such as a random access memory, a flash memory, a read-only memory, a programmable read-only memory, an electrically erasable programmable memory, and a register. The storage medium is located in the memory, and the processor reads the information in the memory and completes the steps in the above method embodiments in conjunction with its hardware.

FIG. 17 is a schematic block diagram of an electronic device provided in the embodiments of the present disclosure.

As illustrated in FIG. 17, the electronic device 30 may be the point cloud encoding apparatus or the point cloud decoding apparatus as described in the embodiments of the present disclosure, and the electronic device 30 may include:
a memory 31 and a processor 32, where the memory 31 is used to store a computer program 34 and transmit the computer program 34 to the processor 32, in other words, the processor 32 may call the computer program 34 from the memory 31 and run the computer program 34, to implement the methods in the embodiments of the present disclosure.

For example, the processor 32 may be used to perform the steps in the point cloud decoding method or the point cloud encoding method according to the instructions in the computer program 34.

In some embodiments of the present disclosure, the processor 32 may include but is not limited to:
a general purpose processor, a digital signal processor (DSP), an application specific integrated circuits (ASIC), a field programmable gate array (FPGA) or other programmable logic device, a discrete gate, a transistor logic device, a discrete hardware component, or the like.

In some embodiments of the present disclosure, the memory 31 includes but is not limited to: a volatile memory and/or a non-volatile memory, where the non-volatile memory may be a read-only memory (ROM), a programmable ROM (PROM), an erasable PROM (EPROM), an electrically EPPROM (EEPROM), or a flash memory; and the volatile memory may be a random access memory (RAM), serving as an external cache. As an example and not limitation, a variety of forms of RAMs are available, such as a static RAM (SRAM), a dynamic RAM (DRAM), a synchronous DRAM (SDRAM), a double data SDRAM (DDR SDRAM), an enhanced SDRAM (ESDRAM), a synchronous link (Synchlink) DRAM, (SLDRAM), and a direct memory bus RAM (DR RAM).

In some embodiments of the present disclosure, the computer program 34 may be partitioned into one or more units. The one or more units are stored in the memory 31 and performed by the processor 32, to complete the methods provided in the present disclosure. The one or more units may be a series of computer program instruction segments capable of completing specific functions, and the instruction segments are used to describe the performing process of the computer program 34 in the electronic device 30.

As illustrated in FIG. 17, the electronic device 30 may further include:
a transceiver 33, where the transceiver 33 is connectable to the processor 32 or the memory 31.

The processor 32 may control the transceiver 33 to communicate with other devices, and specifically, may control the transceiver 33 to transmit information or data to other devices, or control the transceiver 33 to receive information or data transmitted by other devices. The transceiver 33 may include a transmitter and a receiver. The transceiver 33 may further include an antenna, and there may be one or more antennas.

It should be understood that various components in the electronic device 30 are connected via a bus system, where the bus system includes not only a data bus but also a power bus, a control bus and a status signal bus.

FIG. 18 is a schematic block diagram of a point cloud encoding and decoding system provided in the embodiments of the present disclosure.

As illustrated in FIG. 18, the point cloud encoding and decoding system 40 may include: a point cloud encoder 41 and a point cloud decoder 42, where the point cloud encoder 41 is used to perform the point cloud encoding method involved in the embodiments of the present disclosure, and the point cloud decoder 42 is used to perform the point cloud decoding method involved in the embodiments of the present disclosure.

The present disclosure further provides a bitstream, and the bitstream is generated according to the above encoding method.

The present disclosure further provides a non-transitory computer-readable storage medium with a computer program stored thereon. The computer program, when performed on a computer, enables the computer to perform the method of the above method embodiments. In other words, the embodiments of the present disclosure further provide a computer program product including instructions, where the instructions, when performed on a computer, enable the computer to perform the method of the above method embodiments.

When implemented using software, all or part of the above embodiments may be implemented in a form of a computer program product. The computer program product includes one or more computer instructions. When loaded and executed on a computer, the computer program instructions produce, in all or in part, a process or function in accordance with the embodiments of the present disclosure. The computer may be a general purpose computer, a special purpose computer, a computer network, or any of other programmable apparatuses. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server, or a data center to another website, computer, server, or data center through wired manner (e.g., coaxial cable, optical fiber, or digital subscriber line (DSL)) or wireless (e.g., infrared, radio, or microwave) manner. The non-transitory computer-readable storage medium may be any available medium to which a computer can access or may be a data storage device, such as a server or a data center that includes one or more available media. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

In several embodiments provided in the present disclosure, it should be understood that the disclosed system, apparatuses and methods may be implemented in other manners. For example, the apparatus embodiments described above are only schematic. For example, the partition of the units is only partition of logical functions, and there may be other partition manners in the actual implementation, such as a plurality of units or components may be combined or integrated into another system, or some features may be ignored or not implemented. In addition, the mutual coupling or direct coupling or communication connection illustrated or discussed may be indirect coupling or communication connection through some interfaces, apparatuses or units, which may be in electrical, mechanical or other forms.

The units described as discrete components may or may not be physically separated, and the components shown as units may or may not be physical units, that is, they may be located at one place, or may be distributed onto a plurality of network units. Some or all of these units may be selected depending on actual requirements to fulfill the purpose of the solution of the embodiments. For example, various functional units in various embodiments of the present disclosure may be integrated into one processing unit, or various units may exist physically alone, or two or more units may be integrated into one unit.

The foregoing descriptions are merely specific implementations of the present disclosure, but the protection scope of the present disclosure is not limited thereto. Any skilled person in the art could readily conceive of variations or replacements within the technical scope of the present disclosure, which shall be all included in the protection scope of the present disclosure. Therefore, the protection scope of the present disclosure shall be subject to the protection scope of claims.

What is claimed is:

1. A point cloud decoding method, comprising:
determining M neighborhood blocks corresponding to a current point in a reference picture of the current point, wherein the current point is a point in a point cloud whose attribute information is to be decoded, M being a positive integer; and
determining an attribute prediction value of the current point based on attribute information of points comprised in the M neighborhood blocks.

2. The method according to claim 1, wherein determining the M neighborhood blocks corresponding to the current point in the reference picture of the current point comprises:
determining a first spatial block of the current point in a current picture;
determining a collocated block of the first spatial block in the reference picture; and
determining M neighborhood blocks of the collocated block in the reference picture as the M neighborhood blocks corresponding to the current point.

3. The method according to claim 2, wherein determining the collocated block of the first spatial block in the reference picture comprises:
determining the collocated block of the first spatial block in the reference picture based on position information of the first spatial block.

4. The method according to claim 3, wherein determining the collocated block of the first spatial block in the reference picture based on the position information of the first spatial block comprises:
determining the collocated block of the first spatial block in the reference picture based on the position information of the first spatial block and a size of the first spatial block.

5. The method according to claim 4, wherein determining the collocated block of the first spatial block in the reference picture based on the position information of the first spatial block and the size of the first spatial block comprises:
determining a block in the reference picture whose position information is consistent with the position information of the first spatial block in the current picture and whose size is consistent with the size of the first spatial block as the collocated block of the first spatial block.

6. The method according to claim 1, wherein determining the attribute prediction value of the current point based on the attribute information of the points comprised in the M neighborhood blocks comprises:
determining at least one first neighboring point among the points comprised in the M neighborhood blocks; and
determining the attribute prediction value of the current point based on attribute information of the at least one first neighboring point.

7. The method according to claim 1, further comprising:
in response to no neighborhood block corresponding to the current point existing in the reference picture, adopting a first determination mode to determine P second neighboring points of the current point, P being an integer; and
determining the attribute prediction value of the current point based on attribute information of the P second neighboring points.

8. The method according to claim 7, wherein the first determination mode is an intra nearest neighbor search mode and/or a block-based inter nearest neighbor search mode.

9. The method according to claim 7, further comprising:
in response to a number of determined second neighboring points of the current point not meeting a second preset number, determining a second reference point corresponding to the current point in the reference picture;
determining at least one third neighboring point of the current point in the reference picture based on the second reference point and a preset search range; and
determining the attribute prediction value of the current point based on attribute information of the at least one third neighboring point.

10. The method according to claim 1, wherein before determining the M neighborhood blocks corresponding to the current point in the reference picture of the current point, the method further comprises:
performing block partitioning on the point cloud; and
wherein determining the M neighborhood blocks corresponding to the current point in the reference picture of the current point comprises:
determining the M neighborhood blocks corresponding to the current point among blocks comprised in the reference picture.

11. The method according to claim 1, wherein the current point is any point in a level-of-detail (LOD) level of the point cloud whose attribute information is to be decoded, and the LOD level of the point cloud is obtained by performing LOD partitioning on the point cloud.

12. A point cloud encoding method, comprising:
determining M neighborhood blocks corresponding to a current point in a reference picture of the current point, wherein the current point is a point in a point cloud whose attribute information is to be encoded, M being a positive integer; and
determining an attribute prediction value of the current point based on attribute information of points comprised in the M neighborhood blocks.

13. The method according to claim 12, wherein determining the M neighborhood blocks corresponding to the current point in the reference picture of the current point comprises:
determining a first spatial block of the current point in a current picture;
determining a collocated block of the first spatial block in the reference picture; and
determining M neighborhood blocks of the collocated block in the reference picture as the M neighborhood blocks corresponding to the current point.

14. The method according to claim 13, wherein determining the collocated block of the first spatial block in the reference picture comprises:
determining the collocated block of the first spatial block in the reference picture based on position information of the first spatial block.

15. The method according to claim 14, wherein determining the collocated block of the first spatial block in the reference picture based on the position information of the first spatial block comprises:
determining the collocated block of the first spatial block in the reference picture based on the position information of the first spatial block and a size of the first spatial block.

16. The method according to claim 15, wherein determining the collocated block of the first spatial block in the reference picture based on the position information of the first spatial block and the size of the first spatial block comprises:
determining a block in the reference picture whose position information is consistent with the position information of the first spatial block and whose size is consistent with the size of the first spatial block as the collocated block of the first spatial block.

17. The method according to claim 12, wherein determining the attribute prediction value of the current point based on the attribute information of the points comprised in the M neighborhood blocks comprises:
determining at least one first neighboring point among the points comprised in the M neighborhood blocks; and
determining the attribute prediction value of the current point based on attribute information of the at least one first neighboring point.

18. The method according to claim 12, further comprising:
in response to no neighborhood block corresponding to the current point existing in the reference picture, adopting a first determination mode to determine P second neighboring points of the current point, P being an integer; and
determining the attribute prediction value of the current point based on attribute information of the P second neighboring points.

19. A point cloud decoding device, comprising: a processor and a memory; wherein
the memory is configured to store a computer program; and
the processor is configured to call the computer program stored in the memory and run the computer program, to enable the point cloud decoding device to perform:
determining M neighborhood blocks corresponding to a current point in a reference picture of the current point, wherein the current point is a point in a point cloud whose attribute information is to be decoded, M being a positive integer; and
determining an attribute prediction value of the current point based on attribute information of points comprised in the M neighborhood blocks.

20. A non-transitory computer-readable storage medium, having a computer program and a bitstream stored thereon, wherein the computer program, when executed by a processor, causes the processor to perform the steps of the point cloud encoding method according to claim 12, to generate the bitstream.
